(19) United States
(12) Patent Application Publication
(10) Pub. No.: US 2012/0081731 A1
(43) Pub. Date: Apr. 5, 2012

(54) PRINTING SYSTEM, PRINTING METHOD, PRINT SERVER, CONTROL METHOD AND COMPUTER-READABLE MEDIUM

(75) Inventor: Shinya Suzuki, Kawasaki-shi (JP)

(73) Assignee: CANON KABUSHIKI KAISHA, Tokyo (JP)

(21) Appl. No.: 13/228,423

(22) Filed: Sep. 8, 2011

(30) Foreign Application Priority Data
Sep. 30, 2010 (JP) 2010-222436

(51) Int. Cl. G06F 3/12

(52) U.S. Cl. 358/1.13

(57) ABSTRACT

A print server which communicates with an information processing apparatus including a virtual printer driver that generates a print job of an intermediate format independent of a printing apparatus, and a printing apparatus, comprises: a storage unit configured to store the print job of the intermediate format received from the information processing apparatus; a conversion unit configured to convert the print job of the intermediate format stored in the storage unit into a first PDL print job printable by the printing apparatus by using a printer driver of the printing apparatus; and a transmission unit configured to transmit the first PDL print job to save the first PDL print job converted by the conversion unit in the printing apparatus.

### BACKGROUND OF THE INVENTION

1. Field of the Invention

The present invention relates to a printing system, printing method, print server, control method, and computer-readable medium for performing pull print control.

2. Description of the Related Art

There has conventionally been proposed a so-called “pull print” printing system capable of outputting print data from a printing apparatus when the user issues a print request to the printing apparatus for print data temporarily stored in a server (see, for example, Japanese Patent No. 4033857). In printing from an application, the user can output print data not from a specific printing apparatus but from a printing apparatus of his choice.

As a re-printing method for a printout the user did not intend, the following system is proposed (see, for example, Japanese Patent Laid-Open No. 2007-304881). More specifically, the UI (User Interface) of a printer driver running on a client PC is displayed on the panel of a printing apparatus. The user operates the UI to designate re-print settings and re-printing.

As a secure print method, there is proposed a printing system which performs authentication by transmitting authentication information from a server to a client and printing apparatus, and inputting authentication information obtained on the client side to the printing apparatus (see, for example, Japanese Patent Laid-Open No. 2003-280866). The server transmits print data to the storage area of the printing apparatus, and notifies the user on the client side of authentication information corresponding to the stored print data. The user inputs the authentication information to the printing apparatus. In printing, the print data can be acquired from the storage area and printed. This system implements secure print with a short user waiting time.

It is difficult for the conventional method to designate a change of print setting information when the user issues a print request from the printing apparatus for print data temporarily stored in the server. Print data temporarily stored in the server has a PDL (Page Description Language) format dependent on the printing apparatus. Hence, PDL data has to be edited according to a print setting information change instruction. For example, assume that the user designates a print setting to impose four pages on one page (to be referred to as 4in1) when he issues a print request from the printing apparatus for print data temporarily stored in the server. At this time, PDL print data temporarily stored in the server needs to be changed to match 4in1. If PDL is a raster format dependent on the resolution of the printing apparatus, a raster image is reduced to implement 4in1, causing various problems of quality degradation such as loss of a thin line. Since PDL has a variety of specifications, much labor is required to cope with these PDL specifications. In the first place, if a PDL specification is not open to the public, no PDL can be changed.

As a method of designating a change of print setting information by the user from the printing apparatus, the UI of a printer driver running on a client PC is displayed on the panel of the printing apparatus. However, it is hard to apply this method to a pull print system. A printing apparatus to output has not been finalized yet when the user designates printing on the client PC to execute pull print. The functions of a printer driver UI for use have to be general-purpose ones independent of the printing apparatus. A printing apparatus to output is finalized only after the user goes to the printing apparatus and operates the panel of the printing apparatus. The functions of the pull print printer driver UI displayed on the panel of the printing apparatus are merely general-purpose ones. In other words, functions specific to the printing apparatus cannot be used, limiting print settable functions.

There is also a method capable of secure print by transmitting authentication information from a server to a client and inputting it to a printing apparatus by the user. Also in this case, a target printing apparatus needs to have already been determined when the client designates printing, so this method cannot be applied to a pull print system. Further, PDL conversion has been completed when the printing apparatus saves print data. It is therefore difficult to change print setting information, as described above.

In addition, it is hard to simultaneously introduce the pull print system and the above-described system which shortens the user waiting time by saving print data in advance in the printing apparatus. At present, a system the user wants for operation is introduced. However, the user sometimes requests integration of the pull print system and the system with a short waiting time, which is a challenge.

### SUMMARY OF THE INVENTION

According to one aspect of the present invention, there is provided a printing system comprising an information processing apparatus including a virtual printer driver which generates a print job of an intermediate format independent of a printing apparatus, a print server which manages the print job, and a printing apparatus, wherein the print server includes a storage unit configured to store the print job of the intermediate format received from the information processing apparatus, a conversion unit configured to convert the print job of the intermediate format stored in the storage unit into a first PDL print job printable by the printing apparatus by using a printer driver of the printing apparatus, and a transmission unit configured to transmit the first PDL print job to save the first PDL print job converted by the conversion unit in the printing apparatus, the storage unit stores the print job of the intermediate format even after generating the first PDL print job, upon receiving a print setting change instruction from the printing apparatus for the print job, the transmission unit transmits, to the printing apparatus, a second PDL print job generated based on changed print setting information and the print job of the intermediate format stored in the storage unit, the printing apparatus includes a save unit configured to save the first PDL print job transmitted from the transmission unit, a printing unit configured to print the print job, a selection unit configured to select a print job, and a setting change transmission unit configured to transmit a print setting information change instruction for the print job selected by the selection unit, when the setting change transmission unit transmits the print setting information change instruction, the printing unit prints using the second PDL print job transmitted from the print server, and when the setting change transmission unit does not transmit the print setting information change instruction, the printing unit prints using the first PDL print job saved in the save unit.

According to another aspect of the present invention, there is provided a print server which communicates with an information processing apparatus including a virtual printer driver that generates a print job of an intermediate format independent of a printing apparatus, and a printing apparatus, comprising: a storage unit configured to store the print job of the intermediate format received from the information processing apparatus; a conversion unit configured to convert the print job of the intermediate format stored in the storage unit into a first PDL print job printable by the printing apparatus by using a printer driver of the printing apparatus; and a transmission unit configured to transmit the first PDL print job to save the first PDL print job converted by the conversion unit in the printing apparatus, wherein the storage unit stores the print job of the intermediate format even after generating the first PDL print job, and upon receiving a print setting change instruction from the printing apparatus for the print job, the transmission unit transmits, to the printing apparatus, a second PDL print job generated based on changed print setting information and the print job of the intermediate format stored in the storage unit.

According to another aspect of the present invention, there is provided a printing method in a printing system including an information processing apparatus including a virtual printer driver which generates a print job of an intermediate format independent of a printing apparatus, a print server which manages the print job, and a printing apparatus, comprising in the print server: a storage step of storing, in a storage unit, the print job of the intermediate format received from the information processing apparatus; a conversion step of converting the print job of the intermediate format stored in the storage unit into a first PDL print job printable by the printing apparatus by using a printer driver of the printing apparatus; and a transmission step of transmitting the first PDL print job to save the first PDL print job converted in the conversion step in the printing apparatus, wherein in the storage step, the print job of the intermediate format is stored even after generating the first PDL print job, and in the transmission step, upon receiving a print setting change instruction from the printing apparatus for the print job, a second PDL print job generated based on changed print setting information and the print job of the intermediate format stored in the storage unit is transmitted to the printing apparatus, and comprising in the printing apparatus: a save step of saving, in a save unit, the first PDL print job transmitted in the transmission step; a printing step of printing the print job; a selection step of selecting a print job; and a setting change transmission step of transmitting a print setting information change instruction for the print job selected in the selection step, wherein in the printing step, when the print setting information change instruction is transmitted in the setting change transmission step, printing is performed using the second PDL print job transmitted from the print server, and when the print setting information change instruction is not transmitted in the setting change transmission step, printing is performed using the first PDL print job saved in the save unit.

According to another aspect of the present invention, there is provided a method of controlling a print server which communicates with an information processing apparatus including a virtual printer driver that generates a print job of an intermediate format independent of a printing apparatus, and a printing apparatus, comprising: a storage step of storing, in a storage unit, the print job of the intermediate format received from the information processing apparatus; a conversion step of converting the print job of the intermediate format stored in the storage unit into a first PDL print job printable by the printing apparatus by using a printer driver of the printing apparatus; and a transmission step of transmitting the first PDL print job to save the first PDL print job converted in the conversion step in the printing apparatus, wherein in the storage step, the print job of the intermediate format is stored even after generating the first PDL print job, and in the transmission step, upon receiving a print setting change instruction from the printing apparatus for the print job, a second PDL print job generated based on changed print setting information and the print job of the intermediate format stored in the storage unit is transmitted to the printing apparatus.

According to another aspect of the present invention, there is provided a computer-readable medium storing a program for causing a computer to function as a storage unit which stores a print job of an intermediate format received from an information processing apparatus, a conversion unit which converts the print job of the intermediate format stored in the storage unit into a first PDL print job printable by a printing apparatus by using a printer driver of the printing apparatus, and a transmission unit which transmits the first PDL print job to save the first PDL print job converted by the conversion unit in the printing apparatus, wherein the storage unit stores the print job of the intermediate format even after generating the first PDL print job, and upon receiving a print setting change instruction from the printing apparatus for the print job, the transmission unit transmits, to the printing apparatus, a second PDL print job generated based on changed print setting information and the print job of the intermediate format stored in the storage unit.

According to the present invention, when the user issues a print request from a printing apparatus for print data temporarily stored in a server, he can designate a change of print settings. While the user confirms a change of print settings and a print job, printer driver installation and PDL conversion are executed. The printing apparatus can print out immediately after the user designates printing. It is determined whether the user has changed print settings. Even in a pull print system capable of print settings, the printing apparatus can print out immediately after the user designates printing when he does not change print settings, thereby integrating the above-mentioned two systems.

Further features of the present invention will become apparent from the following description of exemplary embodiments (with reference to the attached drawings).

### BRIEF DESCRIPTION OF THE DRAWINGS

FIG. 1 is a view exemplifying the configuration of a printing system;

FIG. 2 is a block diagram showing the hardware configuration of each apparatus;

FIG. 3 is a block diagram exemplifying the configuration of the controller unit of a multi-function peripheral;

FIG. 4 is a schematic view for explaining an overall pull print sequence in the printing system;

FIGS. 5A and 5B are tables showing details of each data sequence;

FIG. 6 is a schematic view exemplifying the print window of an application program;

FIGS. 7A and 7B are flowcharts exemplifying the first control processing in the printing system;

FIGS. 8A and 8B are flowcharts exemplifying the second control processing in the printing system;

FIG. 9 is a flowchart showing save processing to a save area in the printing system;

FIGS. 10A and 10B are flowcharts exemplifying the third control processing in the printing system;

FIG. 11 is a flowchart exemplifying the fourth control processing in the printing system;

FIG. 12 is a flowchart exemplifying the fifth control processing in the printing system;

FIGS. 13A, 13B, and 13C are views showing details of data;

FIGS. 14A and 14B are views showing details of data;

FIGS. 15A, 15B, and 15C are schematic views each showing a window displayed on the display unit of the operation unit of the multi-function peripheral;

FIGS. 16A, 16B, and 16C are schematic views each showing a window displayed on the display unit of the operation unit of the multi-function peripheral;

FIG. 17 is a schematic view for explaining an overall pull print sequence in the printing system;

FIG. 18 is a flowchart exemplifying the third and fourth control processes;

FIG. 19 is a schematic view exemplifying a setting change window for the job search order and maximum job save count;

FIG. 20 is a flowchart exemplifying job save processing; and

FIGS. 21A and 21B are flowcharts exemplifying save processing.

### DESCRIPTION OF THE EMBODIMENTS

### First Embodiment

### System Configuration

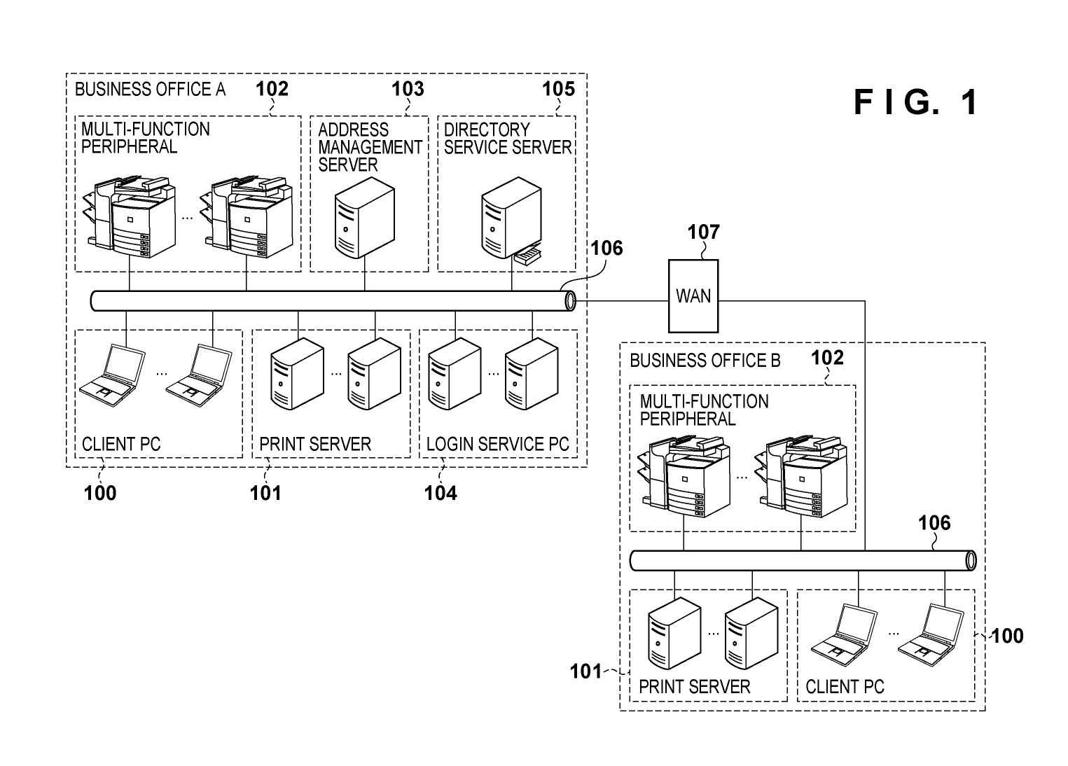

Embodiments of the present invention will now be described with reference to the accompanying drawings. FIG. 1 is a view exemplifying the configuration of a printing system to which an information processing apparatus, print server, address management server, and printing apparatus according to the present invention are applicable. Like “business office A” in FIG. 1, the printing system of the embodiment is configured by connecting one or a plurality of client PCs 100, one or a plurality of print servers 101, one or a plurality of multi-function peripherals 102, an address management server 103, one or a plurality of login service PCs 104, and a directory service server 105 via a local area network (LAN) 106.

A virtual printer driver is installed in the client PC 100. The virtual printer driver generates a print job of an intermediate format independent of a specific multi-function peripheral based on data received from a client application, and transmits it to the print server 101. Note that a print job of an intermediate format indicates print data of a format which has common format specifications open to the public and facilitates reediting. Examples are EMFSPOOL (Enhanced Metafile Spool Format) and PDF (Portable Document Format). The embodiment will adopt the EMFSPOOL format, but print data of another intermediate format such as XPS or PDF is also available.

The print server 101 stores the received print job in a predetermined storage location. The print server 101 includes a job management database (to be referred to as job management DB), and stores metadata regarding the print job in the job management DB. The print server 101 generates print job list information (print job list data) from the metadata stored in the job management DB, and transfers it to the multi-function peripheral 102. The print server 101 updates print setting information using the metadata stored in the job management DB and print setting information received from the multi-function peripheral 102. The print server 101 transfers the updated print setting information to the multi-function peripheral 102. The print server 101 generates PDL (Page Description Language) from the print job saved in the predetermined storage location and the metadata which is recorded and managed in the job management DB. The print server 101 transfers the generated PDL data to the multi-function peripheral 102.

The address management server 103 includes an address management database (to be referred to as address management DB). When executing “pull print” processing in the embodiment, the address management server 103 stores address information (to be referred to as address) of the print server 101 which manages a print job, and a user identifier in the address management DB. In response to a print job list request from the multi-function peripheral 102, the address management server 103 transmits, to the multi-function peripheral 102, the address of a print server 101 corresponding to a user identifier received from the multi-function peripheral 102.

As a login service for the multi-function peripheral 102, the login service PC 104 performs authentication processing based on the login user name and password of the client PC 100 (for example, the login user name and password of Microsoft Windows®) that are stored in the directory service server 105. An example of the authentication processing is SSO (Single Sign-ON). An example of the login service PC 104 is a personal computer in which Security Agent available from CANON is installed.

The directory service server 105 stores information about hardware resources such as a server, client, and printer on a network, and the attributes, access rights, and the like (including the login user name and password of the client PC 100) of users of these hardware resources. An example of the directory service server 105 is a server having an active directory function.

In “business office B”, one or a plurality of client PCs 100, one or a plurality of print servers 101, and one or a plurality of multi-function peripherals 102 are connected via the LAN 106. The printing system of the embodiment may be configured by connecting “business office A” having the above configuration and one or a plurality of “business office B”s via a WAN 107.

As the function of each server, one apparatus may implement the functions of a plurality of servers, or a plurality of apparatuses may implement one function in cooperation with each other.

[Information Processing Apparatus]

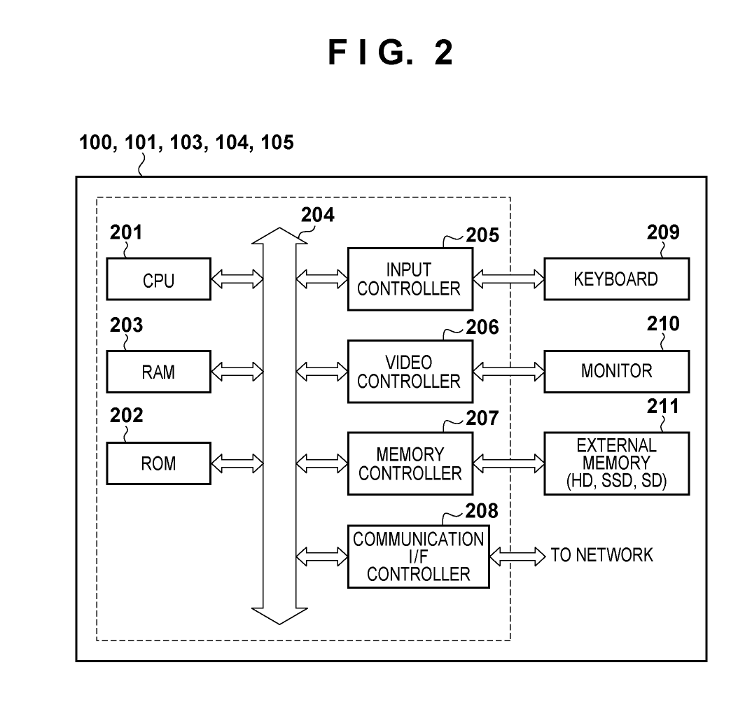

The hardware configuration of an information processing apparatus applicable to the client PC 100, print server 101, address management server 103, login service PC 104, and directory service server 105 shown in FIG. 1 will be explained with reference to FIG. 2. FIG. 2 is a block diagram showing the hardware configuration of the information processing apparatus applicable to the client PC 100, print server 101, address management server 103, login service PC 104, and directory service server 105 shown in FIG. 1.

Referring to FIG. 2, a CPU 201 comprehensively controls respective devices and controllers connected to a system bus 204. A ROM 202 or external memory 211 stores a BIOS (Basic Input/Output System) and operating system program (to be referred to as OS) serving as control programs of the CPU 201, various programs necessary to implement functions to be executed by each server or each PC, and the like. A RAM 203 functions as a main memory, work area, and the like for the CPU 201. The CPU 201 loads, from the ROM 202 or external memory 211 into the RAM 203, programs and the like necessary to execute processing, and executes the loaded programs, implementing various operations. An input controller 205 controls inputs from a keyboard 209, a pointing device such as a mouse (not shown), and the like.

A video controller 206 controls display on a monitor 210. In general, the monitor 210 is a display device such as a liquid crystal display or CRT. The administrator uses such a display device, as needed. A memory controller 207 controls access to the external memory 211 such as a hard disk (HD), SSD (Solid State Drive), or SD memory card which stores a boot program, various applications, edit files, various data, and the like. A communication I/F controller 208 connects/communicates with an external device via a network (for example, the LAN 106 shown in FIG. 1), and executes network communication control processing. For example, communication using TCP/IP is possible. Note that the CPU 201 enables display on the monitor 210 by executing, for example, outline font rasterization processing to a display information area in the RAM 203.

The CPU 201 enables a user instruction with a mouse cursor (not shown) on the monitor 210. Various programs (to be described later) for implementing the present invention are recorded in the external memory 211, and if necessary, loaded into the RAM 203 and executed by the CPU 201. The external memory 211 additionally stores definition files, various information tables, and the like used to execute the programs, which will also be described in detail later.

[Controller Unit]

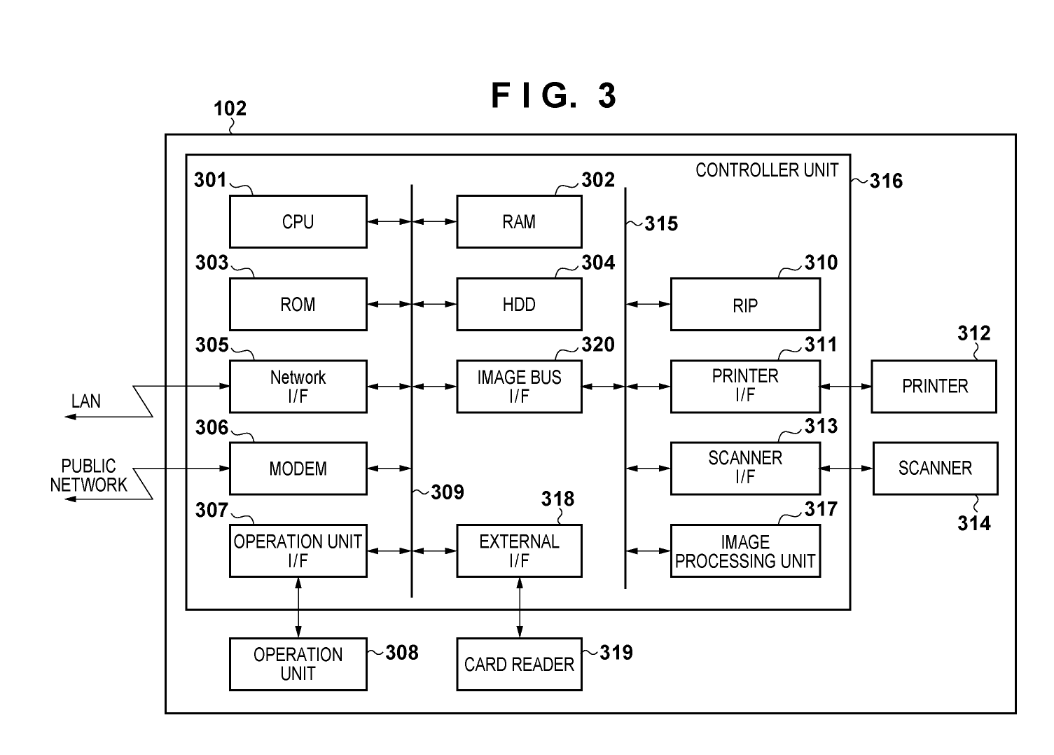

The hardware configuration of a controller unit which controls the multi-function peripheral 102 shown in FIG. 1 will be explained with reference to FIG. 3. FIG. 3 is a block diagram exemplifying the hardware configuration of the controller unit of the multi-function peripheral 102 shown in FIG. 1. Referring to FIG. 3, a controller unit 316 is connected to a scanner 314 functioning as an image input device and a printer 312 functioning as an image output device. In addition, the controller unit 316 is connected to a LAN (for example, the LAN 106 shown in FIG. 1) and a public line (WAN) (for example, PSTN or ISDN) to input/output image data and device information. In the controller unit 316, a CPU 301 is a processor which controls the overall system. A RAM 302 is a system work memory necessary for the CPU 301 to run, and is also a program memory for recording programs and an image memory for temporarily recording image data. A ROM 303 stores a boot program and various control programs for the system. A hard disk drive (HDD) 304 stores various programs for controlling the system, image data, and the like. In the embodiment, the HDD or save area 304 saves a PDL job.

An operation unit interface (I/F) 307 is an interface with an operation unit (UI) 308, and outputs, to the operation unit 308, image data to be displayed on the operation unit 308. Also, the operation unit I/F 307 notifies the CPU 301 of information (for example, user information) input by the system user via the operation unit 308. Note that the operation unit 308 includes a display unit having a touch panel. The user presses (touches with his finger or the like) a button displayed on the display unit to input various instructions. A network interface (I/F) 305 is connected to a network (LAN) to input/output data. A modem 306 is connected to a public line to perform data input/output such as FAX transmission/reception. An external interface (I/F) 318 receives an external input via a USB, IEEE1394, printer port, RS-232C, or the like. In the embodiment, a card reader 319 is connected to the external I/F 318 to read an IC card necessary for authentication. The CPU 301 controls reading of information from the IC card by the card reader 319 via the external I/F 318, and can acquire the information read from the IC card. These devices are arranged on a system bus 309.

An image bus interface (I/F) 320 is a bus bridge which connects the system bus 309 and an image bus 315 for transferring image data at high speed, and converts the data structure. The image bus 315 is formed from a PCI bus or IEEE1394 bus. The following devices are connected to the image bus 315. A raster image processor (RIP) 310 rasterizes vector data such as a PDL code into a bitmap image. A printer interface (I/F) 311 connects the printer 312 and controller unit 316, and performs synchronous/asynchronous conversion of image data. A scanner interface (I/F) 313 connects the scanner 314 and controller unit 316, and performs synchronous/asynchronous conversion of image data. An image processing unit 317 performs correction, processing, and editing for input image data, and performs printer correction, resolution conversion, and the like for printout image data. In addition, the image processing unit 317 rotates image data, and compresses/decompresses multi-valued image data by JPEG or binary image data by JBIG, MMR, MH, or the like.

The scanner 314 illuminates an image on a document sheet, and scans it with a CCD line sensor to convert it into an electrical signal as raster image data. The user sets document sheets in the tray of a document feeder, and designates the start of reading from the operation unit 308. Then, the CPU 301 gives an instruction to the scanner 314, and the feeder feeds the document sheets one by one to read document images. The printer 312 converts raster image data into an image on a sheet. The method of the printer 312 is, for example, an electrophotographic method using a photosensitive drum or photosensitive belt, or an inkjet method of discharging ink from a small nozzle array to directly print an image on a sheet. The type of apparatus is arbitrary as long as the present invention is applicable. The print operation starts in response to an instruction from the CPU 301. Note that the printer 312 includes a plurality of paper feed stages and corresponding paper cassettes so that different paper sizes or different orientations can be selected.

The operation unit 308 includes an LCD display unit, and a touch panel sheet is adhered onto the LCD. The operation unit 308 displays a system operation window, and when the user presses a displayed key, notifies the CPU 301 via the operation unit I/F 307 of the position information. The operation unit 308 includes various operation keys such as a start key, stop key, ID key, and reset key. The start key of the operation unit 308 is used to, for example, start a document image reading operation. An LED of two, green and red colors is arranged at the center of the start key, and the color represents whether the start key is usable. The stop key of the operation unit 308 is used to stop a running operation. The ID key of the operation unit 308 is used to input the user ID. The reset key is used to initialize settings from the operation unit.

The card reader 319 reads information stored in an IC card (for example, FeliCa® available from Sony) under the control of the CPU 301, and notifies the CPU 301 via the external I/F 318 of the read information. With this configuration, the multi-function peripheral 102 can transmit image data scanned by the scanner 314 to the LAN 106, and use the printer 312 to print out print data received from the LAN 106. Also, the multi-function peripheral 102 can FAX-send image data scanned by the scanner 314 to the public line via the modem 306, and use the printer 312 to output image data FAX-received from the public line.

[Pull Print Processing Sequence]

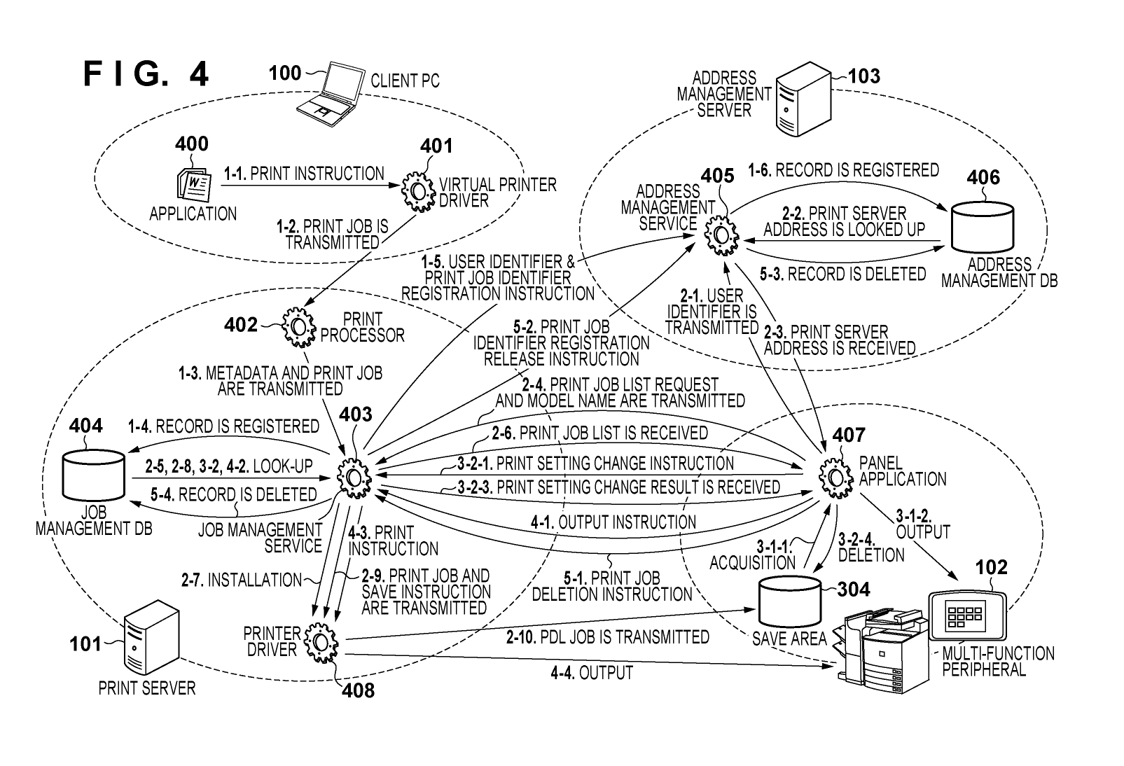

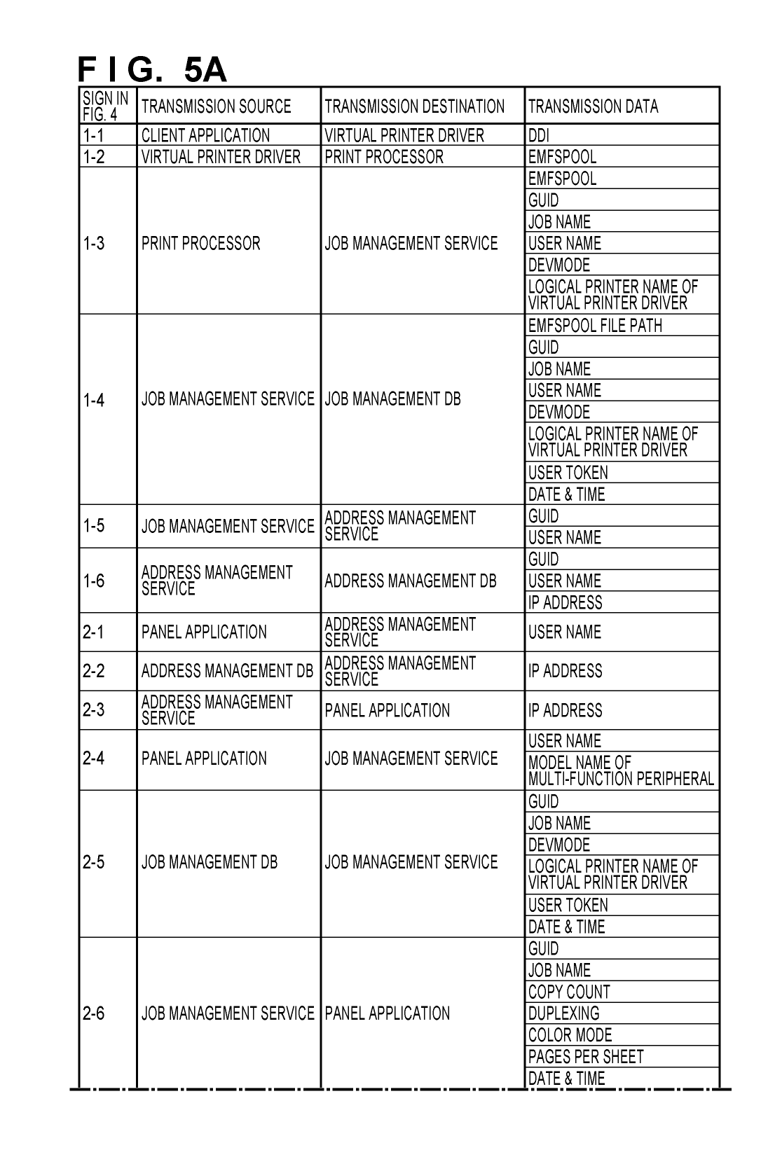

An overall pull print sequence in the printing system according to the embodiment will be explained with reference to FIG. 4. Before this, preconditions to execute pull print in the embodiment will be explained first. A virtual printer driver for implementing pull print in the embodiment is installed as a shared printer in the client PC 100. The virtual printer driver has a function of generating an EMFSPOOL print job based on designated printing or output of a rendering instruction from a client application 400. Further, the virtual printer driver has a function (user interface) of receiving setting of print setting information, and a function of storing the print setting information in an external storage device for each installed logical printer. The print setting information is stored in a DEVMODE structure for Windows® available from Microsoft, USA. The DEVMODE structure is defined by Microsoft, USA to store various settings including default operation conditions regarding a logical printer, such as functions usable by a printer, layout setting, finishing setting, paper feed/discharge setting, and print quality setting. This information is stored in the external storage device for each installed logical printer. Each client PC 100 downloads a virtual printer driver 401 from the print server 101 by point & print or the like, and installs it, thereby adding the logical printer of the virtual printer driver. The print server 101 also installs a printer driver specific to each printer. In FIG. 4, a printer driver 408 for the multi-function peripheral 102 is installed in the print server 101.

The overall pull print sequence according to the embodiment will be described. FIG. 4 is a schematic view for explaining the overall sequence of pull Print® in the printing system according to the embodiment. As shown in FIG. 4, the user first logs into the client PC 100, and inputs a print instruction from the client application 400 executed by the client PC 100 to a logical printer corresponding to the virtual printer driver 401 (1-1). At this time, the user can set print setting information using the virtual printer driver. Note that print setting information settable here is not one specialized to a specific printing apparatus and is limited to general-purpose contents. For example, the print setting information is one all printers can cope with. In accordance with the print instruction, the client application 400 of the client PC 100 transmits data to the virtual printer driver 401 via a graphic engine. The virtual printer driver 401 of the client PC 100 generates a device-independent EMFSPOOL print job based on the data received from the client application via the graphic engine (not shown). The client PC 100 transmits the generated EMFSPOOL print job to the print server 101 (1-2).

In the print server 101, a print processor 402 reads the EMFSPOOL print job transmitted from the virtual printer driver 401, and generates metadata of the print job. The print processor 402 transmits the metadata and the print job to a job management service 403 (1-3). The job management service 403 saves the EMFSPOOL print job in a predetermined storage location in the print server 101. Further, the job management service 403 registers the metadata in a job management DB 404 (built in the external storage device of the print server 101) (1-4). At this time, the print server 101 only saves the EMFSPOOL print job in the predetermined storage location without transmitting it to the printing apparatus. Further, the print server 101 transmits a print job identifier and user identifier to register them in an address management service 405 in the address management server 103 (1-5).

Upon receiving the print job identifier and user identifier from the job management service 403, the address management service 405 registers them in an address management DB 406 in addition to the address of the print server 101 (1-6). In the embodiment, the address management DB 406 is built in the external storage device of the address management server 103. Note that the embodiment uses an IP address as an address for discriminating a device. The embodiment uses a GUID (Global Unique Identifier) as the job identifier.

When the multi-function peripheral 102 detects an IC card readable by the card reader 319, it reads individual authentication information in the IC card, and transmits the read individual authentication information as an authentication request to an authentication server (not shown). The individual authentication information is information used for authentication and may be the serial number of the IC card. The individual authentication information is not particularly limited as long as it can uniquely identify a user. Upon receiving the individual authentication information from the multi-function peripheral 102, the authentication server performs authentication processing for the individual authentication information based on an IC card authentication table stored in the external storage device of the authentication server, and sends back the authentication result to the multi-function peripheral 102. Assume that the authentication server transmits the user identifier of the client PC 100 as the authentication result if the authentication processing is successful. A device having this function is arbitrary as long as the authentication server function can be implemented, and may reside in, for example, the address management server 103.

A panel application 407 in the multi-function peripheral 102 receives the authentication result (login user identifier of the client PC 100) indicating that authentication is successful. The embodiment uses a user name as the user identifier. Needless to say, the method for identifying a user may be the serial number of an IC card or the like.

The panel application 407 requests a print job list of the print server 101. Before this, the panel application 407 executes preprocessing to acquire the IP address of the print server 101 in order to acquire a print job list. First, the panel application 407 transmits a user identifier to the address management service 405 in the address management server 103 (2-1). This implements an address solution instruction unit. The address management service 405 acquires, from the address management DB 406, the address of a print server 101 corresponding to the received user name (2-2). Then, the address management service 405 sends back the address of the print server 101 to the panel application 407 (2-3). By receiving the address, the panel application 407 implements an address reception unit.

Upon receiving the address of the print server 101 from the address management service 405, the panel application 407 requests a print job list of the job management service 403 in the print server 101 based on the acquired address. At this time, the panel application 407 transmits the model name of the multi-function peripheral 102 at the same time as the print job list request (2-4). Accordingly, the panel application 407 implements a list request transmission unit. By receiving the print job list request, the job management service 403 implements a list request reception unit. The job management service 403 looks up the job management DB 404 (2-5), generates a print job list corresponding to the user identifier, and sends back the print job list to the panel application 407 (2-6). This implements a list transmission unit. By receiving the print job list, the panel application 407 implements a list reception unit. Upon receiving the print job list from the job management service 403, the panel application 407 displays the print job list on the UI of the operation unit 308.

Then, the job management service 403 installs a printer driver 408 suited to the model by using the model name transmitted from the panel application 407 (2-7). The job management service 403 looks up the job management DB 404 for target metadata and an EMFSPOOL print job (2-8). The job management service 403 transmits the metadata and EMFSPOOL print job to the printer driver 408 and instructs the printer driver 408 to save them (2-9). At this time, the target metadata and EMFSPOOL print job are determined in an order in which the job management service 403 referred to them. The printer driver 408 performs PDL conversion, and transmits the PDL job to save it in the save area 304 in the multi-function peripheral 102 (2-10). The PDL job indicates a job obtained by converting an EMFSPOOL print job into the PDL format. When the PDL job is saved in the save area 304, the multi-function peripheral 102 can print it without the mediacy of the printer driver 408 again. This can shorten the user waiting time.

When the user selects a print job and issues a print setting information change instruction and print instruction, the panel application 407 confirms whether print setting information has been changed in the panel application 407, and determines a print processing order. If no print setting information has been changed, the panel application 407 acquires, from the save area 304, a PDL job corresponding to the job designated by the panel application 407 (3-1-1). The panel application 407 controls to print the acquired PDL job by the multi-function peripheral 102 (3-1-2). After the end of printing, the multi-function peripheral 102 deletes the PDL job from the save area. Depending on settings of the multi-function peripheral 102, the PDL job can be left. After that, the panel application 407 advances to print job deletion processing.

If print setting information has been changed, the panel application 407 transmits, to the print server 101, the changed print setting information of the user-designated print job (3-2-1). This implements a setting change transmission unit. By receiving the transmitted print setting information, the panel application 407 implements a setting change reception unit. Upon receiving the print setting information from the panel application 407, the job management service 403 looks up the job management DB 404 (3-2-2), and changes the print setting information. The job management service 403 sends back the changed print setting information to the panel application 407 (3-2-3). This implements a setting transmission unit. By receiving the updated print setting information, the panel application 407 implements a setting reception unit. The panel application 407 compares the transmitted print setting information with the received one to determine whether the print setting change instruction was executed correctly. If the print setting change instruction was executed correctly, the panel application 407 deletes the PDL job (PDL job before setting change) saved in the save area 304 (3-2-4).

The panel application 407 again issues a print request (output instruction) to the job management service 403 (4-1). This implements a print request transmission unit. By receiving the print request, the job management service 403 implements a print request reception unit. Upon receiving the print instruction from the panel application 407, the job management service 403 looks up the job management DB 404 and acquires information necessary to print the print job (4-2). Then, the job management service 403 issues a print instruction to the printer driver 408 based on the print instruction (4-3). More specifically, the EMFSPOOL print job and the like are transmitted to the printer driver. In accordance with this instruction, the printer driver 408 converts the referred metadata and EMFSPOOL print job into a PDL job, and transmits the PDL job to the multi-function peripheral 102 (4-4). Note that print setting information used in conversion is changed print setting information transmitted from the panel application in (3-2-1). This implements a job transmission unit, and the multi-function peripheral 102 prints the PDL job. Note that the PDL job is a job that is obtained by converting an EMFSPOOL print job into the printable PDL format. The job converted into the PDL format can be output by the multi-function peripheral 102. With the function of determining a change of print setting information, a printing method can be automatically determined based on a user instruction, and data can be output in a printing time optimum for the user.

Finally, when the user designates deletion of a print job, the panel application 407 instructs the job management service 403 to delete the designated print job (5-1). Upon receiving the print job deletion request from the panel application 407, the job management service 403 instructs the address management service 405 to delete a registered print job identifier (5-2). Upon receiving the print job identifier registration release request from the job management service 403, the address management service 405 deletes a corresponding record from the address management DB 406 (5-3). The job management service 403 deletes a corresponding record from the job management DB (5-4), and deletes even an EMFSPOOL print job file.

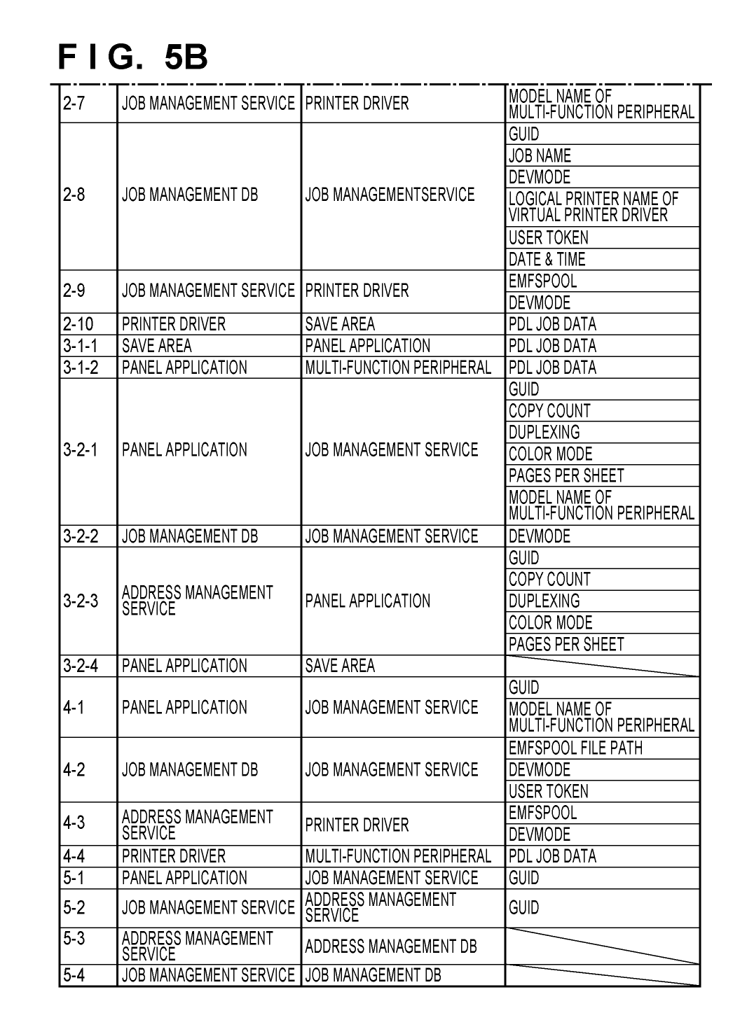

The overall pull print sequence has been described. FIGS. 5A and 5B show details of data in the printing system of FIG. 4 in the table form. Processing will be described in detail with reference to flowcharts. At this time, the description will be complemented with reference to FIGS. 5A and 5B.

[Print Instruction Operation]

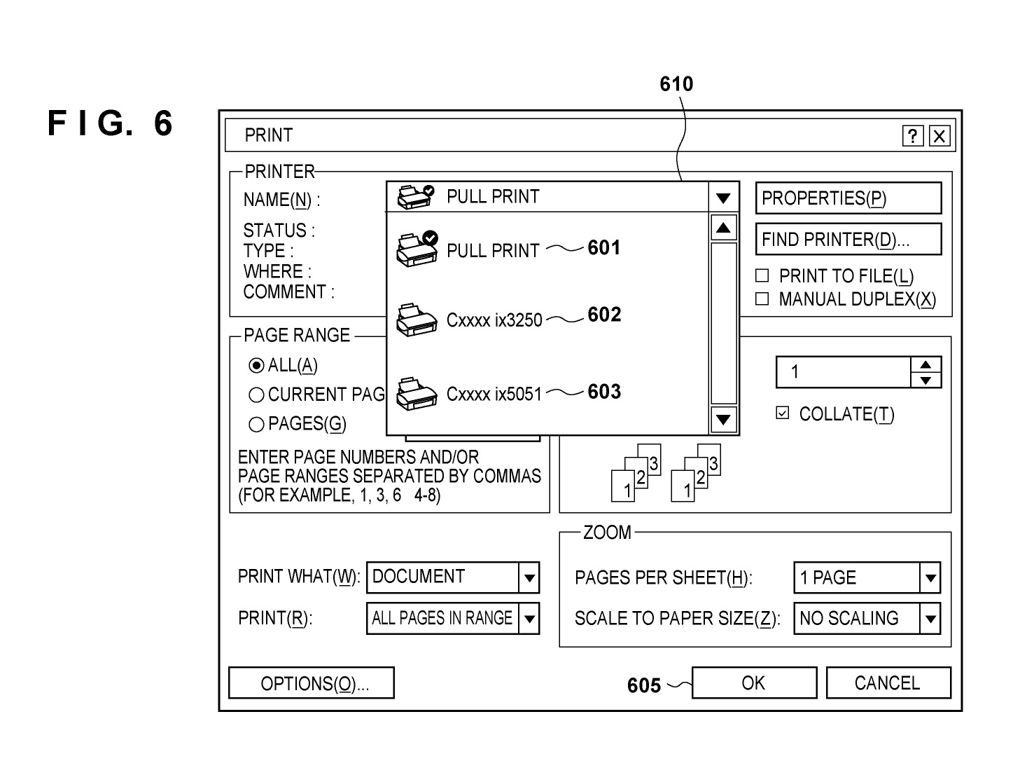

A print instruction in the client application 400 running on the client PC 100 shown in FIG. 1 will be explained. FIG. 6 is a schematic view exemplifying the print window of the client application 400 running on the client PC 100 shown in FIG. 1. The display unit displays the print window under the control of the CPU of the client PC 100. A printer selection field 610 allows the user to select a logical printer to print from logical printers set in the client PC 100.

In the printer selection field 610, “pull print” 601 is a logical printer corresponding to a virtual printer driver set for pull print in the embodiment. Further in the printer selection field 610, “Cxxxx ix3250” 602 and “Cxxxx ix5051” 603 are logical printers corresponding to normal printer drivers. The user selects one logical printer in the printer selection field 610, and designates an OK button 605 with a pointing device (not shown). Then, the client application 400 transmits print data via the graphic engine to a printer driver corresponding to the logical printer selected in the printer selection field 610. The operation of the virtual printer driver when the user selects the “pull print” 601 in the printer selection field 610 and issues a print instruction will be explained.

[First Control Processing]

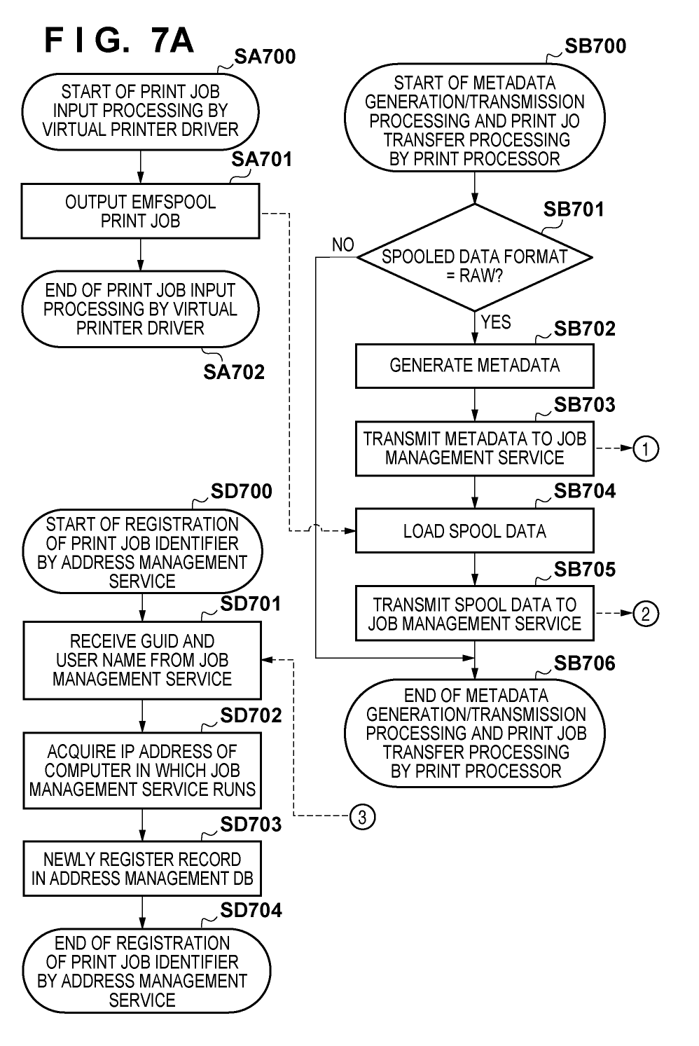

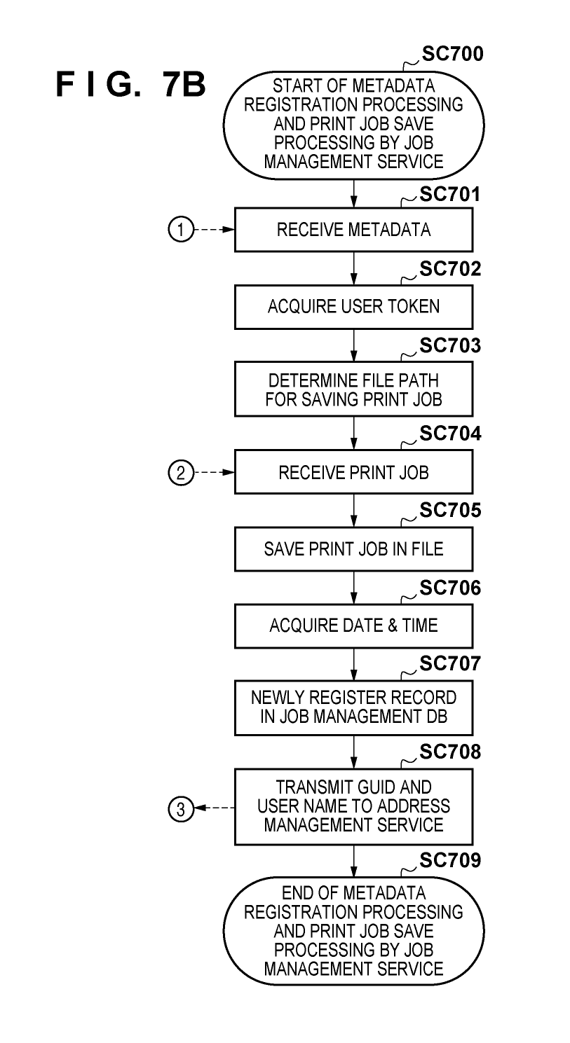

FIGS. 7A and 7B are flowcharts exemplifying the first control processing sequence in the printing system according to the present invention. This sequence corresponds to the processing sequence from 1-1 to 1-6 shown in FIG. 4. In the flowchart shown in FIGS. 7A and 7B, solid arrows indicate the sequence of processes, and broken arrows indicate data transmission/reception between apparatuses.

Steps SA700 to SA702 correspond to print job input processing by the virtual printer driver 401 shown in FIG. 4. These flowchart processes are implemented by loading a program stored in the external memory into the RAM and executing it by the CPU of the client PC 100 shown in FIG. 1.

Steps SB700 to SB706 correspond to metadata generation/transmission processing and print job transfer processing by the print processor 402 shown in FIG. 4. These flowchart processes are implemented by loading a program stored in the external memory into the RAM and executing it by the CPU of the print server 101 shown in FIG. 1.

Steps SC700 to SC709 correspond to metadata registration processing and print job save processing by the job management service 403 shown in FIG. 4. These flowchart processes are implemented by loading a program stored in the external memory into the RAM and executing it by the CPU of the print server 101 shown in FIG. 1.

Steps SD700 to SD704 correspond to print job identifier registration processing by the address management service 405 shown in FIG. 4. These flowchart processes are implemented by loading a program stored in the external memory into the RAM and executing it by the CPU of the address management server 103 shown in FIG. 1.

First, print job input processing by the virtual printer driver 401 of the client PC 100 will be explained. In step SA700, processing by the virtual printer driver 401 starts. In step SA701, the virtual printer driver 401 outputs data input from the client application 400 in FIG. 4 as an EMFSPOOL print job. This corresponds to 1-1 and 1-2 in FIG. 4. For Windows® available from Microsoft, USA, input to the printer driver is executed by a function call by the OS (Operating System) which is called DDI (Device Driver Interface).

The virtual printer driver 401 interprets a parameter transferred at the same time as the DDI call, generates an EMFSPOOL print job, and outputs the generated job to a spooler managed by the OS. In general, the role of the printer driver is to generate and output a print job dependent on an output device. In the embodiment, it is important to generate and output a print job of an intermediate format independent of the multi-function peripheral 102. Hence, even if the configuration of the multi-function peripheral 102 is changed, that of the virtual printer driver 401 does not change in the printing system of the present invention. That is, a function unique to the multi-function peripheral can be easily used in the pull print system. In step SA702, the process ends.

Next, metadata generation/transmission processing and print job transfer processing by the print processor 402 of the print server 101 will be explained. For Windows® available from Microsoft, USA, internal processing by a PrintDocumentOnPrintProcessor function called when the OS requests the print processor to process a print job will be described. In step SB700, the print processor 402 starts processing on the print server 101. In step SB701, the print processor 402 acquires information about the format of a print job which has been output from the virtual printer driver 401 and managed by the OS. The print processor 402 determines whether the type of job output to the spooler of the OS is the RAW format. The RAW format indicates a print job output from the printer driver. Since the virtual printer driver 401 has output the print job in step SA701, it is determined that the job type is the RAW format, and the process advances to step SB702. If it is determined that the job type is not the RAW format, the process advances to step SB706 and ends. In step SB702, the print processor 402 generates metadata.

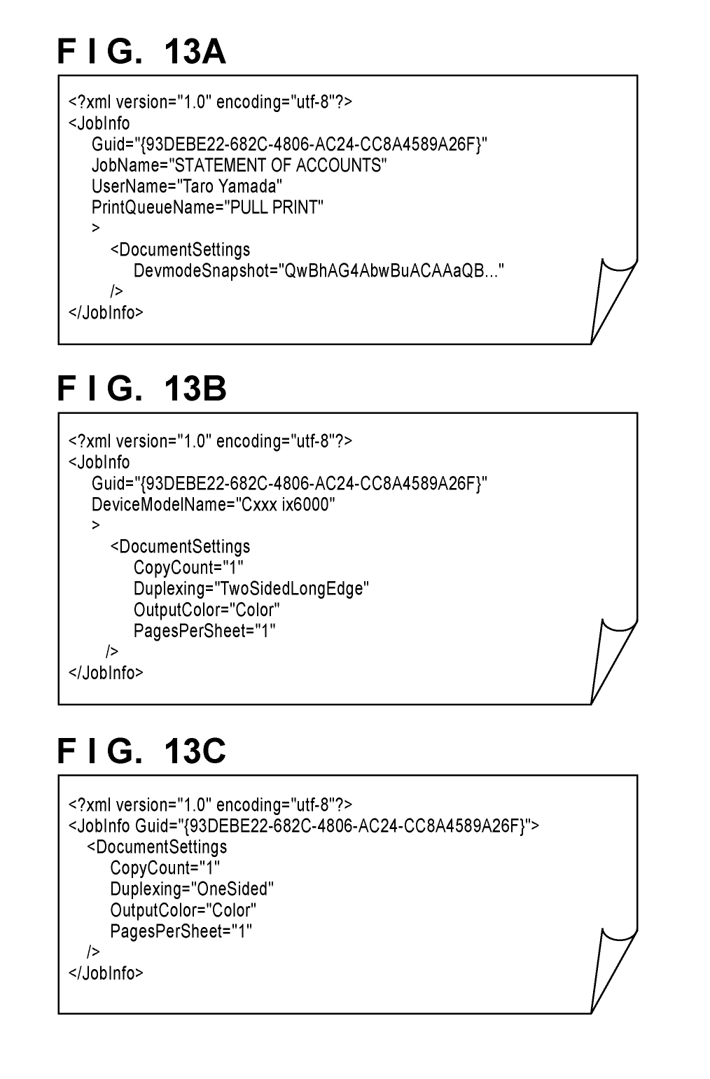

Metadata includes the GUID (Global Unique Identifier), job name, user name, DEVMODE, and logical printer name of the virtual printer driver on the “transmission data” column on the “1-3” row in FIGS. 5A and 5B. More specifically, the metadata is expressed in the XML format as shown in FIG. 13A. The Guid attribute of the JobInfo element describes a print job identifier which is unique in the printing system of the present invention. The JobName attribute of the JobInfo element describes the name of a job designated in process 1-1 of FIG. 4. The UserName attribute of the JobInfo element describes the name of a user who printed in process 1-1 of FIG. 4. The PrintQueueName attribute of the JobInfo element describes the name of a logical printer used in process 1-1 of FIG. 4. The DEVMODESnapshot attribute of the DocumentSettings element describes print setting information (DEVMODE) of the first page designated in process 1-1 of FIG. 4. Note that the DEVMODE is a binary format, and is converted into a text by a Base64 method to describe data by XML.

In step SB703, the print processor 402 transmits the metadata generated in step SB702 to the job management service 403. For Windows® available from Microsoft, USA, a named pipe can be used as a transmission protocol efficiently. The use of the named pipe is convenient even for acquisition of a user token (to be described later). In step SB704, the print processor 402 loads spool data from the spooler of the OS. The spool data corresponds to the EMFSPOOL print job output from the virtual printer driver 401. In step SB705, the print processor 402 transmits the loaded spool data to the job management service 403. In step SB706, the process ends.

Metadata registration processing and print job save processing by the job management service 403 will be described. In step SC700, the job management service 403 starts processing on the print server 101. In step SC701, the job management service 403 functions as a named pipe server and receives the metadata transmitted from the print processor 402 in step SB703 in the XML format as shown in FIG. 13A. When establishing a connection with the print processor 402, the job management service 403 acquires the user token of a named pipe client (that is, the print processor 402) (step SC702). The usage of the user token will be described later.

In step SC703, the job management service 403 determines a file path for saving the print job. In step SC704, the job management service 403 receives the EMFSPOOL print job transmitted from the print processor 402 in step SB705. In step SC705, the job management service 403 saves the received EMFSPOOL print job with the file name determined in step SC703. In step SC706, the job management service 403 generates the current date & time as the print job input time.

In step SC707, the job management service 403 registers, as a new record in the job management DB 404 of FIG. 4, the metadata received in step SC701, the user token acquired in step SC702, the file name determined in step SC703, and the date & time generated in step SC706. In step SC708, the job management service 403 transmits a print job identifier registration command to the address management service 405. At this time, the job management service 403 transmits even the GUID and user name contained in the metadata received in step SC701. In step SC709, the process ends.

Next, print job identifier registration processing by the address management service 405 will be explained. In step SD700, the address management service 405 starts processing on the address management server 103. In step SD701, the address management service 405 receives the GUID and user name transmitted from the job management service 403 in step SC708. When establishing a connection with the job management service 403, the address management service 405 acquires the IP address of the print server 101 (step SD702). In step SD703, the address management service 405 registers, as a new record in the address management DB 406 of FIG. 4, the GUID and user name received in step SD701 and the IP address acquired in step SD702. In step SD704, the process ends.

[Second Control Processing]

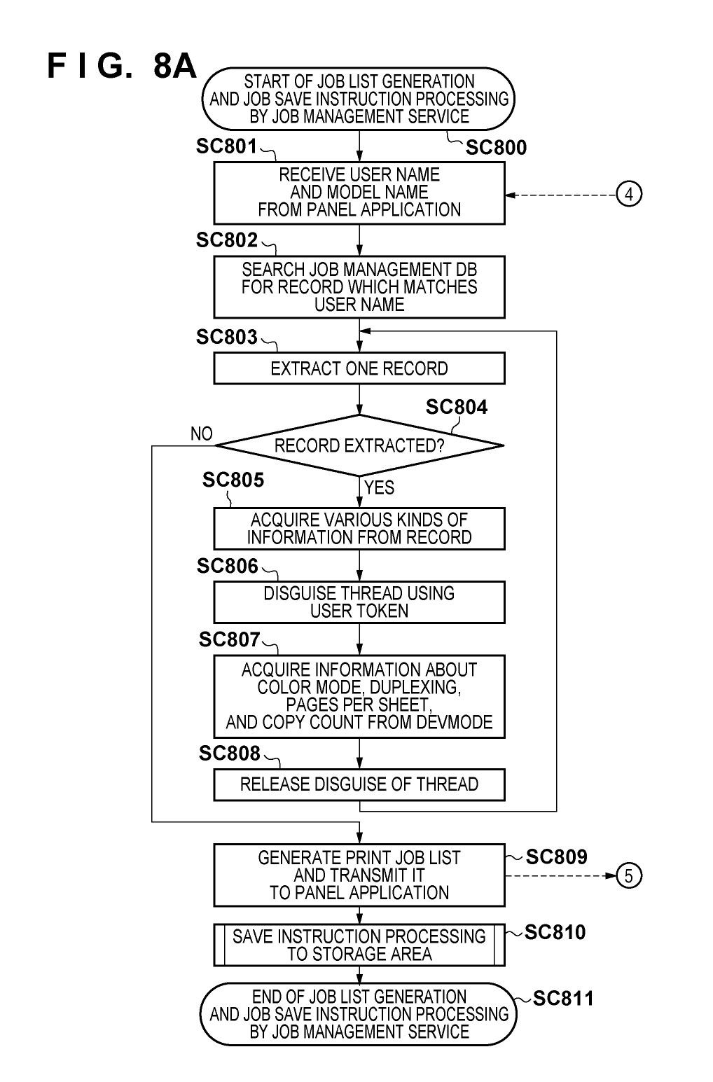

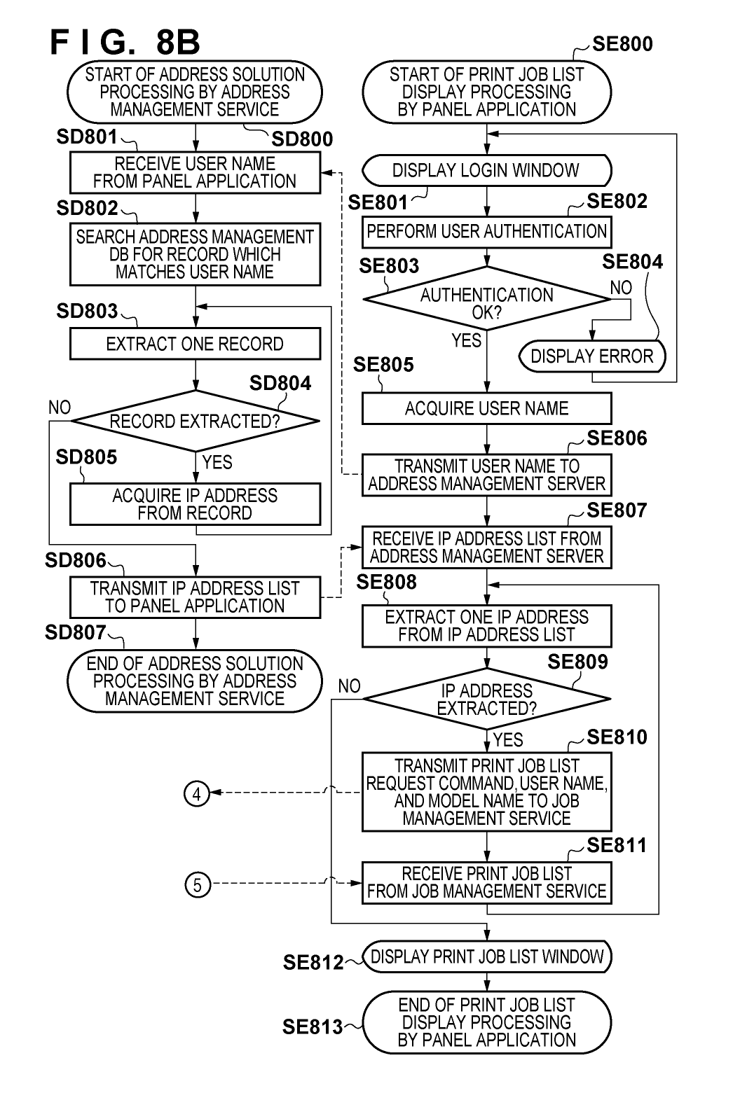

FIGS. 8A and 8B are flowcharts exemplifying the second control processing sequence in the printing system according to the present invention. This sequence corresponds to the processing sequence from 2-1 to 2-10 shown in FIG. 4. In the flowcharts shown in FIGS. 8A and 8B, solid arrows indicate the sequence of processes, and broken arrows indicate data transmission/reception between apparatuses.

Steps SE800 to SE813 correspond to print job list display processing by the panel application 407 shown in FIG. 4. These flowchart processes are implemented by loading a program stored in the external memory into the RAM and executing it by the CPU of the multi-function peripheral 102 shown in FIG. 1.

Steps SD800 to SD807 correspond to address solution processing by the address management service 405 shown in FIG. 4. These flowchart processes are implemented by loading a program stored in the external memory into the RAM and executing it by the CPU of the address management server 103 shown in FIG. 1.

Steps SC800 to SC811 correspond to print job list generation processing and job save instruction processing by the job management service 403 shown in FIG. 4. These flowchart processes are implemented by loading a program stored in the external memory into the RAM and executing it by the CPU of the print server 101 shown in FIG. 1.

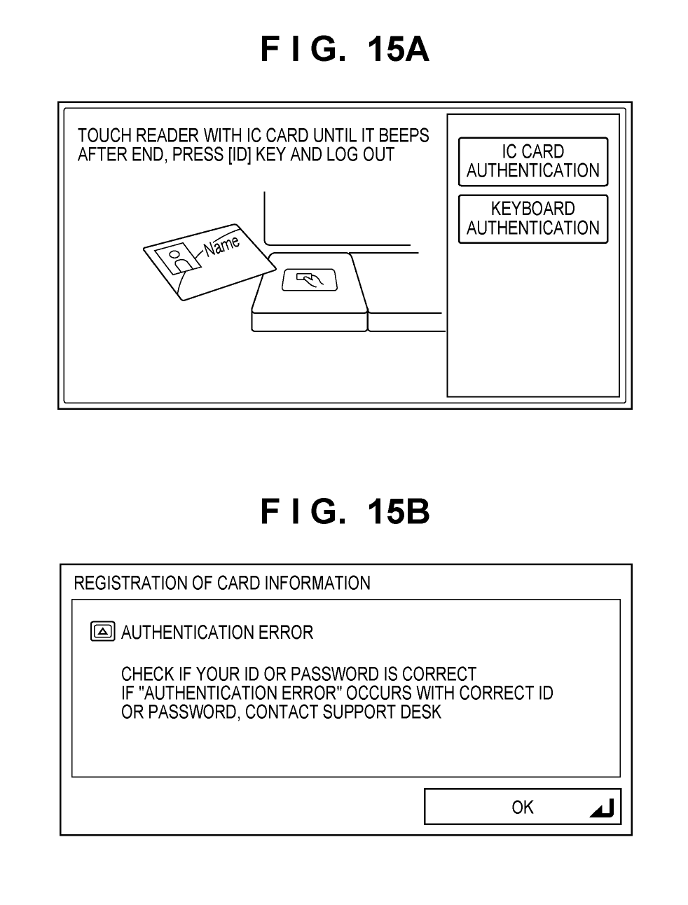

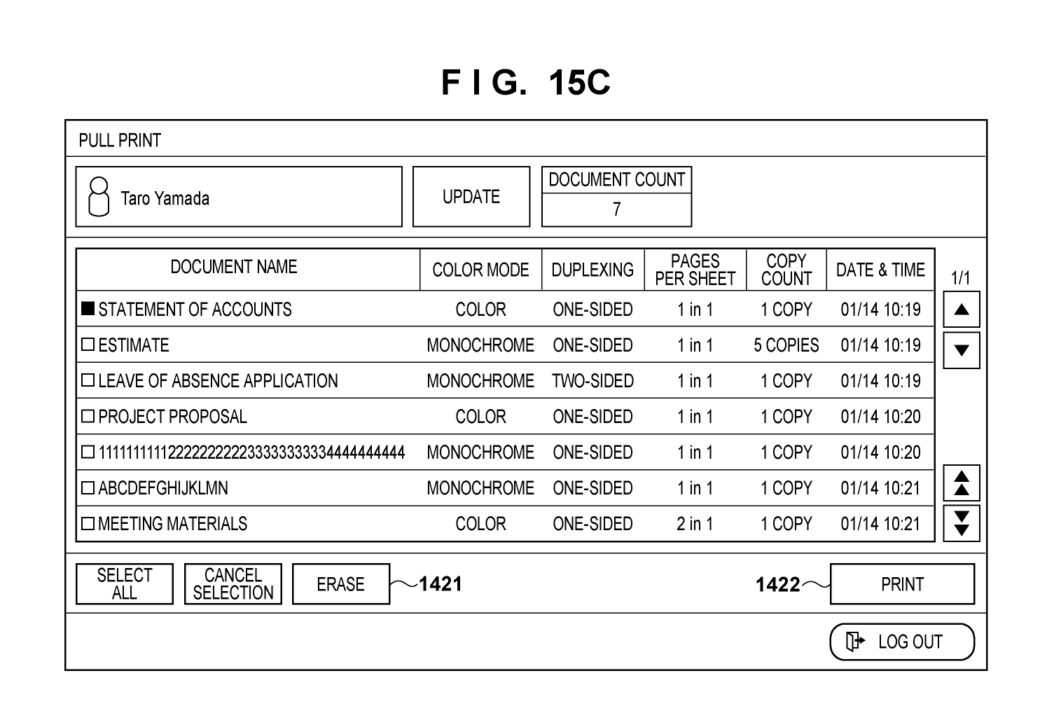

First, print job list display processing by the panel application 407 will be explained. In step SE800, processing by the panel application 407 starts. In step SE801, the panel application 407 controls to display a login display window (FIG. 15A) on the operation unit 308. In step SE802, the panel application 407 performs user authentication based on an IC card or the like. In the embodiment, user authentication is not an important process, so a detailed description of an authentication card detection method, an IC card identification ID acquisition method, and authentication processing by an authentication server will be omitted.

In step SE803, the panel application 407 determines the authentication result. If the authentication result indicates an authentication error in step SE803, the panel application 407 controls in step SE804 to display an error display window (FIG. 15B) on the display unit of the operation unit 308. If the panel application 407 receives pressing of the OK button on the error display window, it returns to step SE801 and controls to display the login display window again. If the panel application 407 determines in step SE803 that authentication is successful, the process advances to step SE805. In step SE805, the panel application 407 acquires the name of a user who has been authenticated successfully. In step SE806, the panel application 407 transmits a user name to the address management service 405. In step SE807, the panel application 407 receives the IP address list of the print server 101 from the address management service 405. More specifically, the panel application 407 requests the address management service 405 to narrow down target print jobs based on the user name, and send back IP addresses of job management service at which the print jobs are held.

Subsequent steps SE808 to SE811 are loop processing of listing IP addresses from the IP address list. In step SE808, the panel application 407 extracts an IP address from the IP address list. In step SE809, the panel application 407 determines whether an IP address has been extracted. If an IP address has been extracted, the process advances to step SE810, and the panel application 407 transmits a print job list request command to the job management service 403. At this time, the user name and model name are transmitted together. In step SE811, the panel application 407 receives a print job list from the job management service 403.

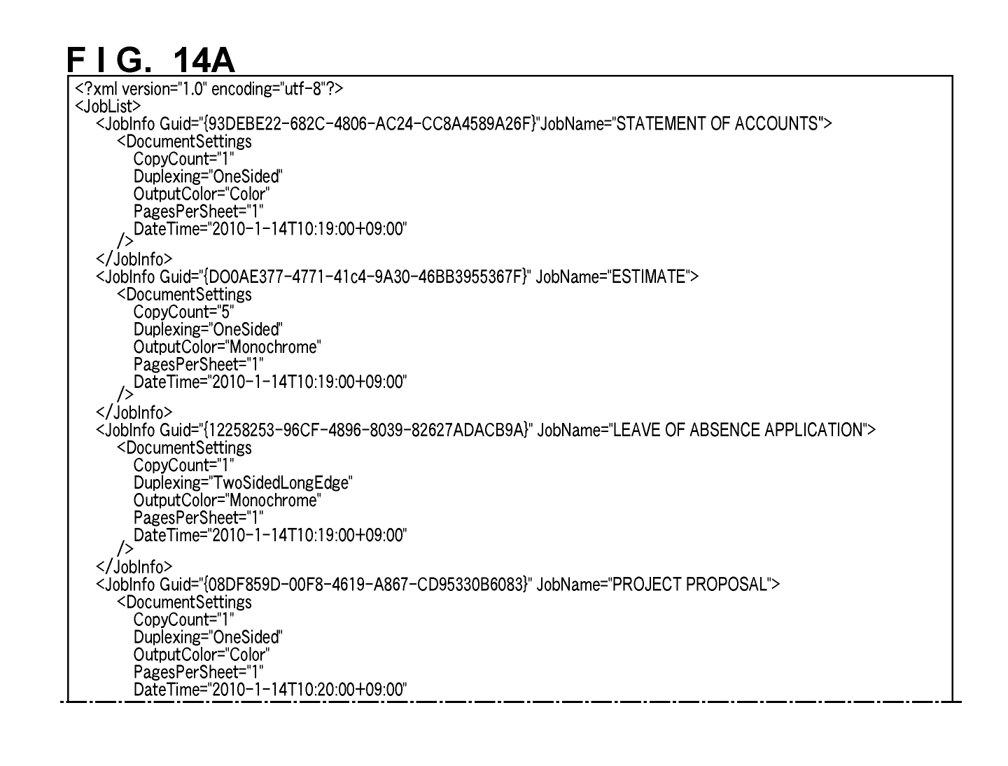

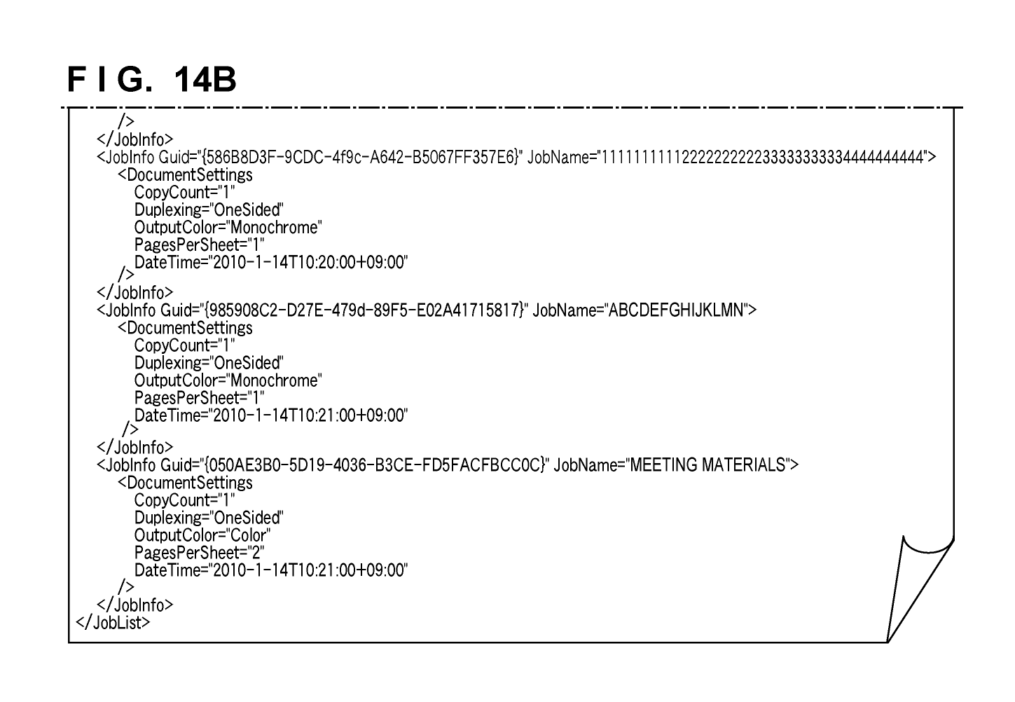

The print job list includes the GUID, job name, copy count, duplexing, color mode, pages per sheet, and date & time on the “transmission data” column on the “2-6” row in FIGS. 5A and 5B. More specifically, the print job list is expressed as print job list information in the XML format as shown in FIGS. 14A and 14B. The JobList element holds JobInfo child elements by the number of jobs. The Guid attribute of the JobInfo element is the same as Guid described with reference to FIG. 13A. The JobName attribute of the JobInfo element is also the same as JobName described with reference to FIG. 13A. However, various attributes held by the DocumentSettings element greatly differ from those in FIG. 13A.

The CopyCount attribute designates the number of copies. The Duplexing attribute designates which of one-sided printing and two-sided printing is used. More specifically, a description “OneSided” designates one-sided printing. A description “TwoSidedLongEdge” designates two-sided (long-edge binding). A description “TwoSidedShortEdge” designates two-sided (short-edge binding). The OutputColor attribute designates an output method regarding color. A description “Color” designates color. A description “Monochrome” designates monochrome. The PagesPerSheet attribute designates the number of pages which can be selected for printing on one surface of a sheet. The DateTime attribute designates the job input time. After the panel application 407 ends extraction of an IP address from the IP address list in steps SE808 to SE811, the process advances to step SE812. In step SE812, the panel application 407 controls to display a print job list display window (FIG. 15C) on the operation unit 308. In step SE813, the process ends.

Next, address solution processing by the address management service 405 will be explained. In step SD800, processing by the address management service 405 starts. In step SD801, the address management service 405 receives the user name transmitted from the panel application 407 in step SE806. In step SD802, the address management service 405 searches the address management DB 406 in FIG. 4 for a record which matches the user name received in step SD801. In step SD803, the address management service 405 extracts one record from detected records. In step SD804, the address management service 405 determines whether the record has been extracted. If the record has been extracted, the process advances to step SD805, and the address management service 405 extracts, from the record, the IP address of the print server 101 in which the job management service 403 runs. After the end of extracting IP addresses from all detected records in steps SD803 to SD805, the process advances to step SD806, and the address management service 405 sends back the IP address list to the panel application 407. In step SD807, the process ends.

Print job list generation and job save instruction processing by the job management service 403 will be explained. In step SC800, processing by the job management service 403 starts. In step SC801, the job management service 403 receives the print job list request transmitted from the panel application 407 in step SE810. At this time, the job management service 403 receives the user name and model name, too. In step SC802, the job management service 403 searches the job management DB 404 in FIG. 4 for a record which matches the user name received in step SC801. In step SC803, the job management service 403 extracts one record from detected records.

In step SC804, the job management service 403 determines whether the record has been extracted. If the record has been extracted, the process advances to step SC805, and the job management service 403 extracts a GUID, a job name, a DEVMODE, the logical printer name of a virtual printer driver, a user token, and date & time from the record. In step SC806, the job management service 403 “disguises” its thread using the user token extracted in step SC805. While the thread is disguised, it is executed in the security context of a user who printed using the client application 400 in FIG. 4. That is, “disguise” indicates executing a thread with user authority using the security context of the user. “Thread” indicates a thread generated upon a change of print setting information.

In step SC807, the job management service 403 extracts pieces of information such as the color mode, duplexing, pages per sheet, and copy count from the DEVMODE extracted in step SC805. The DEVMODE is a printer driver-specific data format managed by the printer driver. To extract pieces of information from the DEVMODE, an inquiry need to be made to a printer driver which has generated the DEVMODE. Since the logical printer name of the virtual printer driver has been acquired in step SC807, pieces of information are extracted from the DEVMODE using the logical printer.

In general, pieces of information are extracted from the DEVMODE via an original expansion interface which is arranged in the printer driver to operate the DEVMODE. Recently, there is a method using an XML print setting storage format called a print ticket defined by Microsoft, USA. If the printer driver supports the print ticket, it is also possible to convert the DEVMODE into a print ticket and extract pieces of information from the print ticket.

In step SC808, the job management service 403 releases the disguise of the thread. After the end of extracting pieces of print setting information from all detected records in steps SC803 to SC808, the process advances to step SC809, and the job management service 403 generates a print job list (FIGS. 14A and 14B). The job management service 403 sends back the print job list to the panel application 407. In step SC810, PDL job save instruction processing to the save area 304 of the multi-function peripheral 102 is performed. Step SC810 will be described later. In step SC811, the process ends. A PDL print job transmitted in step SC810 is also called the first PDL print job.

[Save Processing]

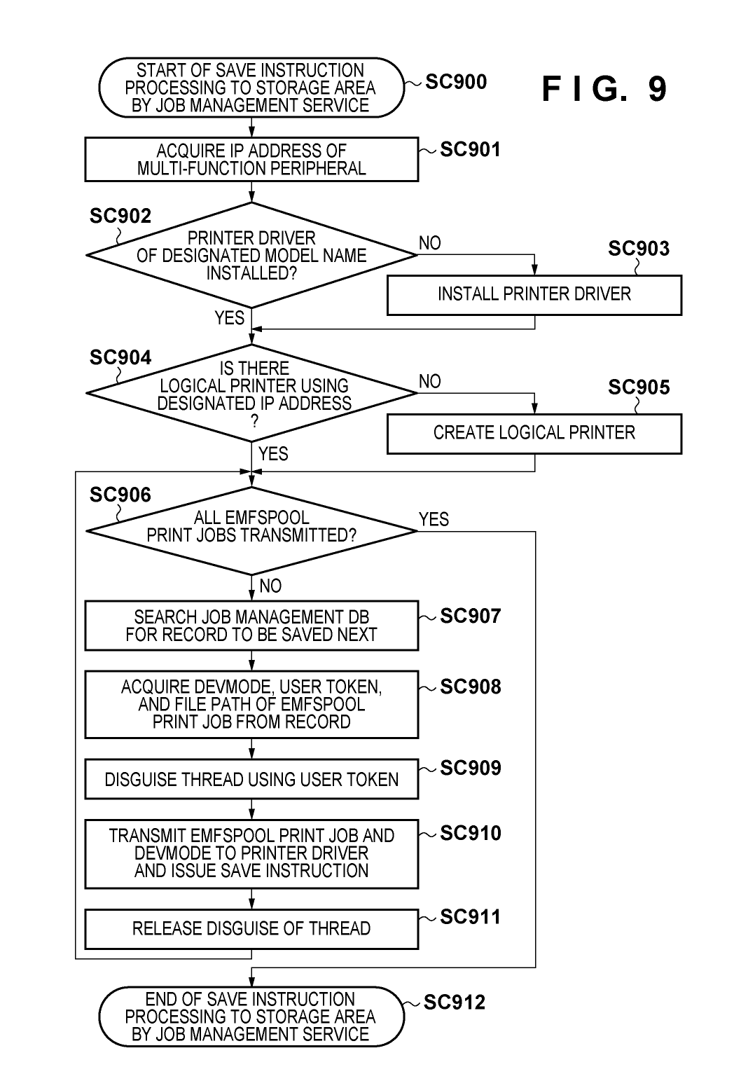

FIG. 9 is a flowchart showing PDL job save processing to the save area 304 in the multi-function peripheral 102 that is called in step SC810 of FIG. 8A. This sequence corresponds to the processing sequence from 2-7 to 2-10 shown in FIG. 4.

In step SC900, processing by the job management service 403 starts. In step SC901, the job management service 403 acquires the IP address of the multi-function peripheral 102 in FIG. 1. The IP address of the multi-function peripheral 102 is acquired when a data transmission/reception connection with the panel application 407 is established. In step SC902, the job management service 403 determines whether a printer driver which supports the model name of the multi-function peripheral 102 in FIG. 1 has been installed in the print server 101. If no such printer driver has been installed, the process advances to step SC903, and the job management service 403 installs, in the print server 101, a printer driver which supports the model name of the multi-function peripheral 102 in FIG. 1. The process then advances to step SC904. If the job management service 403 determines in step SC902 that such a printer driver has been installed, the process advances to step SC904. At this stage, the installed printer driver is the printer driver 408 in FIG. 4.

In step SC904, the job management service 403 determines whether a logical printer which is formed from the installed printer driver and has the IP address acquired in step SC901 as an output port exists in the print server 101. If no such logical printer exists, the process advances to step SC905, and the job management service 403 creates a logical printer which is formed from the printer driver installed in step SC903 and has the IP address acquired in step SC901 as an output port. The process then advances to step SC906. If the job management service 403 determines in step SC904 that such a logical printer exists, the process advances to step SC906.

In step SC906, the job management service 403 determines whether all EMFSPOOL print jobs registered in the job management DB 404 have been transmitted to the printer driver 408. If the job management service 403 determines that not all EMFSPOOL print jobs have been transmitted, the process advances to step SC907. In step SC907, the job management service 403 searches the job management DB 404 for a record to be transmitted next, and acquires a target record. In step SC908, the job management service 403 acquires a DEVMODE, a user token, and the file path of an EMFSPOOL print job from the target record acquired in step SC907. In step SC909, the job management service 403 disguises its thread using the user token acquired in step SC908. While the thread is disguised, it is executed in the security context of a user who printed using the client application 400 in FIG. 4. In step SC910, the job management service 403 transmits the acquired EMFSPOOL print job and DEVMODE using the file path acquired in step SC908 to the printer driver 408, and instructs the printer driver 408 to save them in the save area 304 of the multi-function peripheral 102. The printer driver 408 generates a PDL print job to be saved in the save area 304 of the multi-function peripheral 102, and transmits it to the multi-function peripheral 102. In step SC911, the job management service 403 releases the disguise of the thread, and the process advances to step SC906.

If the job management service 403 determines in step SC906 that all jobs have been transmitted, the process advances to step SC912, and save instruction processing by the job management service 403 ends. Although not shown in FIG. 9, each processing step in the flowchart has a function of externally receiving a stop signal. If a stop signal is externally received, the job management service 403 suspends processing after the step in which the stop signal was received.

By the above sequence, the printer driver 408 is installed in the print server 101 after user authentication. The printer driver 408 performs PDL conversion using an EMFSPOOL print job and transmits the generated PDL print job to the multi-function peripheral 102. The PDL print job is saved in the save area 304.

[Third Control Processing]

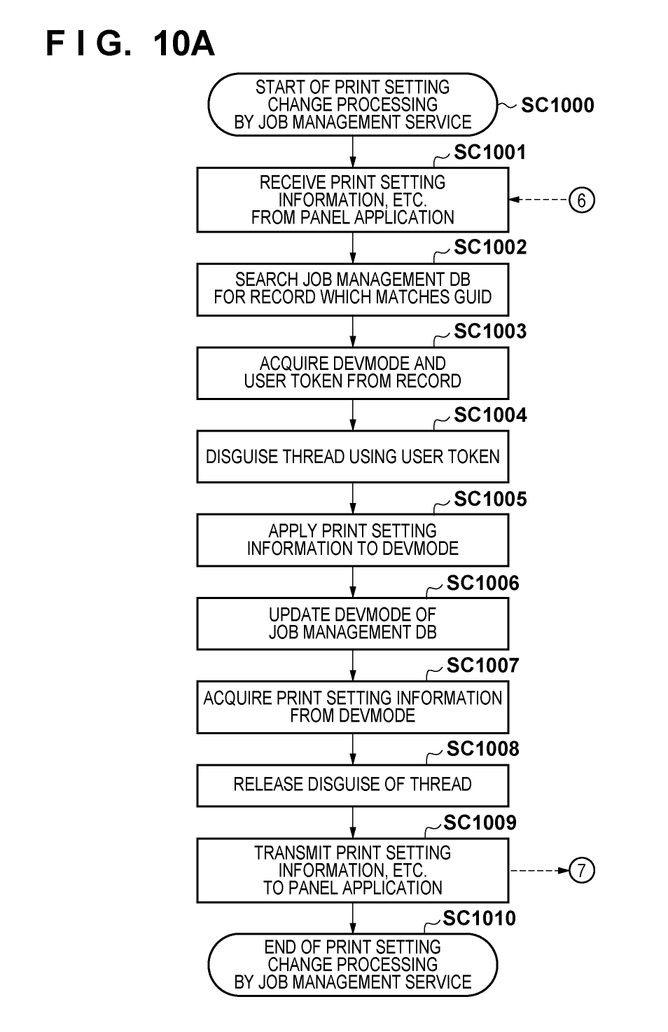

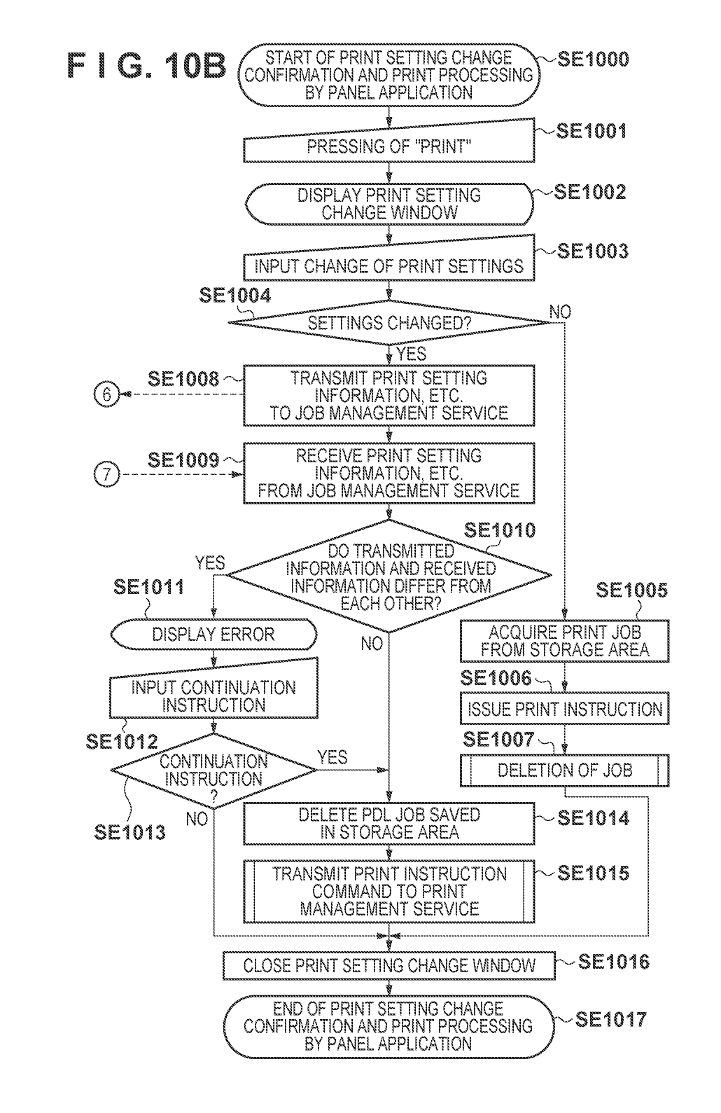

FIGS. 10A and 10B are flowcharts exemplifying the third control processing sequence in the printing system according to the present invention. This sequence corresponds to the processing sequence from 3-1-1, 3-1-2, and 3-2-1 to 3-2-4 shown in FIG. 4. In the flowcharts shown in FIGS. 10A and 10B, solid arrows indicate the sequence of processes, and broken arrows indicate data transmission/reception between apparatuses.

Steps SE1000 to SE1015 correspond to print setting change confirmation and print instruction processing by the panel application 407 shown in FIG. 4. These flowchart processes are implemented by loading a program stored in the external memory into the RAM and executing it by the CPU of the multi-function peripheral 102 shown in FIG. 1.

Steps SC1000 to SC1010 correspond to processing by the job management service 403 shown in FIG. 4. These flowchart processes are implemented by loading a program stored in the external memory into the RAM and executing it by the CPU of the print server 101 shown in FIG. 1.

First, print setting information change confirmation and print instruction processing by the panel application 407 will be explained. In step SE1000, processing by the panel application 407 starts. In step SE812 of FIG. 8B, the CPU 301 of the multi-function peripheral 102 controls to display the print job list display window (FIG. 15C) on the operation unit 308.

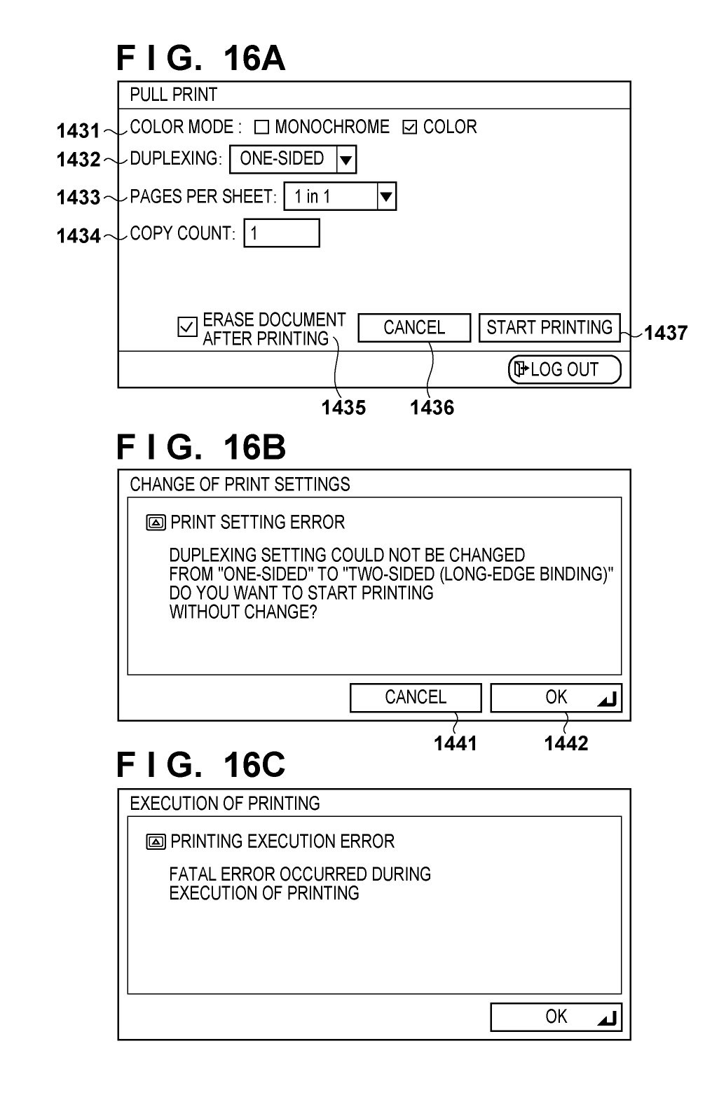

In step SE1001, the panel application 407 receives selection of a print job and pressing of a print button 1422 from the user. In step SE1002, the panel application 407 controls to display a print setting change window (FIG. 16A) on the operation unit 308. A setting 1431 in FIG. 16A indicates designation of the color mode, and allows the user to check either monochrome or color. A setting 1432 in FIG. 16A indicates designation of two-sided/one-sided, and allows the user to select one of one-sided, two-sided (long-edge binding), and two-sided (short-edge binding). A setting 1433 in FIG. 16A indicates designation of pages per sheet, and allows the user to select one of 1in1, 2in1, 4in1, 6in1, 8in1, 9in1, and 16in1. A setting 1434 in FIG. 16A indicates designation of the copy count, and allows the user to designate a value of 1 to 9,999. FIG. 16A exemplifies a change of print setting information upon receiving selection of a print job with a document name “statement of accounts” in FIG. 15C and pressing of the print button 1422.

In step SE1003, the panel application 407 receives a change of print setting information from the user. In step SE1004, the panel application 407 determines whether the print setting information has been changed. If the panel application 407 determines that no print setting information has been changed, the process advances to step SE1005. This corresponds to 3-1-1 and 3-1-2 in FIG. 4. In step SE1005, the panel application 407 acquires, from the save area 304, a print job (PDL print job) designated by the user. In step SE1006, the panel application 407 causes the multi-function peripheral 102 to print the print job acquired in step SE1005. The process then advances to step SE1007. Job deletion instruction processing in step SE1007 will be described later. After that, the process advances to step SE1016. In step SE1016, the panel application 407 closes the print setting change window. In step SE1017, print processing by the panel application 407 ends.

By the above sequence, when no print setting information is changed, the saved PDL job can be used and output from the printing apparatus immediately after receiving a print instruction from the user.

If the panel application 407 determines in step SE1004 that the print setting information has been changed, the process advances to step SE1008. This corresponds to 3-2-1 to 3-2-4 in FIG. 4. In step SE1008, the panel application 407 transmits print setting information to the job management service 403. The print setting information includes the GUID, copy count, duplexing, color mode, pages per sheet, and model name of the multi-function peripheral on the “transmission data” column on the “3-2-1” row in FIGS. 5A and 5B.

More specifically, the print setting information is expressed in the XML format as shown in FIG. 13B. The Guid attribute of the JobInfo element is the same as Guid described with reference to FIG. 13A. The DeviceModelName attribute of the JobInfo element describes the model name of the multi-function peripheral 102 in FIG. 1. Various attributes held by the DocumentSettings element are the same as those described with reference to FIG. 13A. However, one-sided has been changed to two-sided (long-edge binding) in step SE1004, so the Duplexing attribute becomes “TwoSidedLongEdge”. In step SE1009, the panel application 407 receives, from the job management service 403, print setting information which reflects the print setting information change instruction. The print setting information includes the GUID, copy count, duplexing, color mode, and pages per sheet on the “transmission data” column on the “3-2-3” row in FIGS. 5A and 5B. More specifically, the print setting information is expressed in the XML format as shown in FIG. 13C. The contents are almost the same as those in FIG. 13B, and a description thereof will not be repeated.

In step SE1010, the panel application 407 compares the print setting information transmitted in step SE1008 with one received in step SE1009. As described above, the Duplexing attribute in the print setting information transmitted in step SE1008 designates “TwoSidedLongEdge”. However, assume that the Duplexing attribute in the print setting information received in step SE1009 is “OneSided”. Such a mismatch between transmitted and received settings is highly likely to occur in principle.

Setting information which is not changed in step SE1003 is, for example, the paper size. Assume that the paper size is “postcard” in 1-1 of FIG. 4. As a print setting information prohibition condition, assume that two-sided/one-sided designation allows selection of only one-sided for paper “postcard”. Further, the preferential order to apply the prohibition condition is higher for paper size designation than for two-sided/one-sided designation. Thus, the Duplexing attribute has to be always “OneSided”. If the same advanced prohibition processing as that of the printer driver is implemented in the panel application 407, a change of duplexing designation can be prohibited in input of a setting change in FIG. 16A. However, this greatly complicates implementation of the panel application. It is therefore easy and versatile to inquire of the printer driver whether a change is possible every time print setting information is changed, without performing print setting information prohibition processing by the panel application 407, like the embodiment.

If the print setting information transmitted in step SE1008 and one received in step SE1009 are identical as a result of comparison, the process advances to step SE1014. If they are different, the process advances to step SE1011, and the panel application 407 controls to display an error display window (FIG. 16B) on the display unit of the operation unit 308. Since the Duplexing attribute of the print setting information received in step SE1009 is “OneSided”, the error display in FIG. 16B represents that a change from “one-sided” to “two-sided (long-edge binding)” has failed. In step SE1012, the panel application 407 receives input of a print continuation instruction. In step SE1013, the panel application 407 receives pressing of an OK button 1442, and the process advances to step SE1014.

In step SE1014, the panel application 407 deletes the PDL job saved in the save area 304. The process then advances to step SE1015. However, when save of the PDL job has not been completed, the panel application 407 cannot delete the PDL job. In this case, the panel application 407 transmits a suspend processing signal to the job management service 403 immediately. Thereafter, the process advances to step SE1015. Print instruction processing in step SE1015 will be described later. The process then advances to step SE1016. If the panel application 407 receives pressing of a cancel button 1441 via the error display window of FIG. 16B, the process advances to step SE1016. In step SE1016, the panel application 407 closes the error display window in FIG. 16B and the print setting information change window in FIG. 16A. In step SE1017, the process ends.

Next, print setting information change processing by the job management service 403 will be explained. In step SC1000, processing by the job management service 403 starts. In step SC1001, the job management service 403 receives print setting information transmitted from the panel application 407 in step SE1008 in the XML format as shown in FIG. 13B. In step SC1002, the job management service 403 searches the job management DB 404 in FIG. 4 for a record which matches the GUID received in step SC1001.

In step SC1003, the job management service 403 acquires a DEVMODE and user token from the detected record. In step SC1004, the job management service 403 disguises its thread using the user token acquired in step SC1003. While the thread is disguised, it is executed in the security context of a user who printed using the client application 400 in FIG. 4. In step SC1005, the job management service 403 applies pieces of print setting information received in step SC1001 to the DEVMODE acquired in step SC1003. The DEVMODE is a printer driver-specific data format managed by the printer driver. To apply pieces of information to the DEVMODE, a printer driver which has generated the DEVMODE is requested to update the DEVMODE.

The logical printer has been generated in step SC810 of FIG. 8A and can be used to apply pieces of information to the DEVMODE. In general, pieces of information are applied to the DEVMODE via an original expansion interface which is arranged in the printer driver to operate the DEVMODE. Recently, there is a method using an XML print setting storage format called a print ticket defined by Microsoft, USA. If the printer driver supports the print ticket, it is also possible to convert the DEVMODE into a print ticket, apply pieces of information to the print ticket, and convert the print ticket into a DEVMODE.

In step SC1006, the job management service 403 updates the DEVMODE saved in the job management DB 404 using the DEVMODE changed in step SC1005. In step SC1007, the job management service 403 extracts pieces of information such as the color mode, duplexing, pages per sheet, and copy count from the DEVMODE updated in step SC1006. Extraction of pieces of information is the same as that in step SC807 of FIG. 8A. In step SC1008, the job management service 403 releases the disguise of the thread. In step SC1009, the job management service 403 sends back, to the panel application 407, the print setting information which has been changed into the XML format as shown in FIG. 13C. In step SC1010, the process ends. However, print setting information in which only the setting 1434 (copy count) in FIG. 16A has been changed can be processed within the multi-function peripheral 102. For this reason, the process need not advance from step SE1004 to step SE1008.

[Fourth Control Processing]

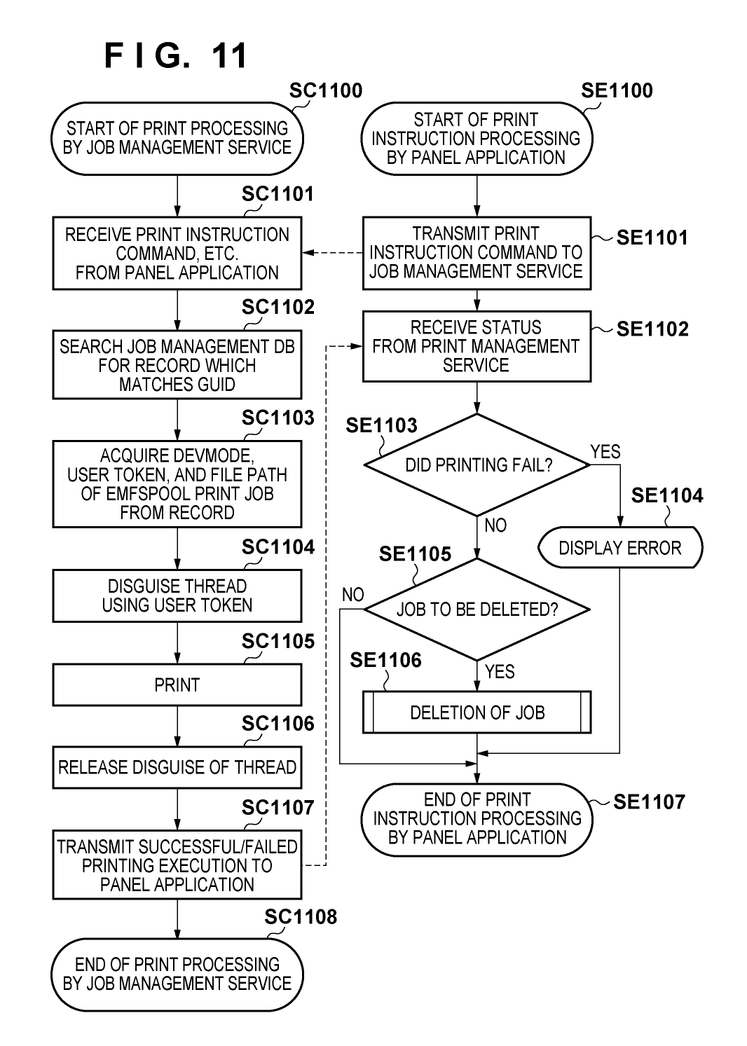

FIG. 11 is a flowchart exemplifying the fourth control processing sequence in the printing system according to the present invention, and is also a flowchart showing print instruction processing called in step SE1015 of FIG. 10B. This sequence corresponds to the processing sequence from 4-1 to 4-4 shown in FIG. 4. In the flowchart shown in FIG. 11, solid arrows indicate the sequence of processes, and broken arrows indicate data transmission/reception between apparatuses.

Steps SE1100 to SE1107 correspond to print instruction processing by the panel application 407 shown in FIG. 4. These flowchart processes are implemented by loading a program stored in the external memory into the RAM and executing it by the CPU of the multi-function peripheral 102 shown in FIG. 1.

Steps SC1100 to SC1108 correspond to print processing by the job management service 403 shown in FIG. 4. These flowchart processes are implemented by loading a program stored in the external memory into the RAM and executing it by the CPU of the print server 101 shown in FIG. 1.

First, print instruction processing by the panel application 407 will be explained. In step SE1100, processing by the panel application 407 starts. In step SE1101, the panel application 407 transmits a print instruction request command, the GUID of a selected print job, and the model name of the multi-function peripheral 102 to the job management service 403. In step SE1102, the panel application 407 receives a printing execution result (success/failure) from the job management service 403. In step SE1103, the panel application 407 determines whether execution of printing is successful. If execution of printing has failed, the process advances to step SE1104, and the panel application 407 controls to display an error display window (FIG. 16C) on the display unit of the operation unit 308. The process then advances to step SE1107. If the panel application 407 determines in step SE1103 that execution of printing is successful, the process advances to step SE1105.

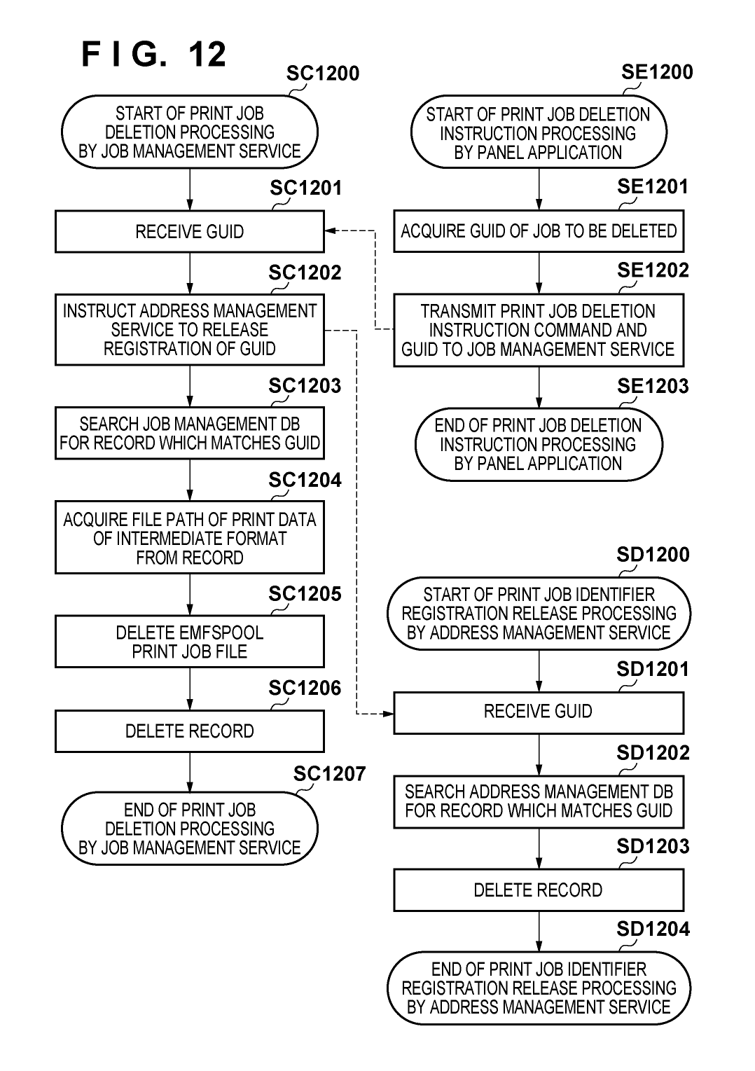

In step SE1105, the panel application 407 determines whether a printed document erase check box 1435 in FIG. 16A has been checked. If deletion after printing is designated, the process advances to step SE1106, and the panel application 407 deletes the print job. Details of this processing will be described later with reference to FIG. 12. The process then advances to step SE1107. In step SE1107, the process ends.

Next, print processing by the job management service 403 will be explained. In step SC1100, processing by the job management service 403 starts. In step SC1101, the job management service 403 receives the print instruction command and the GUID of the target print job that have been transmitted from the panel application 407 in step SE1101. In step SC1102, the job management service 403 searches the job management DB 404 in FIG. 4 for a record which matches the GUID received in step SC1101. In step SC1103, the job management service 403 acquires an EMFSPOOL file name, DEVMODE, and user token from the detected record.

In step SC1104, the job management service 403 disguises its thread using the user token acquired in step SC1103. While the thread is disguised, it is executed in the security context of a user who printed using the client application 400 in FIG. 4. In step SC1105, the job management service 403 transmits, to the printer driver 408, the EMFSPOOL print job and DEVMODE which have been acquired in step SC1103. The printer driver 408 which forms a logical printer generates a PDL print job based on the EMFSPOOL print job and DEVMODE which have been received from the job management service 403, and transmits it to the multi-function peripheral 102. Note that the PDL print job transmitted in step SC1105 is also called the second PDL print job. In step SC1106, the job management service 403 releases the disguise of the thread. In step SC1107, the job management service 403 sends back a printing execution result (success/failure) to the panel application 407. In step SC1108, the process ends.

[Fifth Control Processing]

FIG. 12 is a flowchart exemplifying the fifth control processing sequence in the printing system according to the present invention, and is also a flowchart showing print job deletion processing called in step SE1007 of FIG. 10B. Further, FIG. 12 is a flowchart showing print job deletion processing called in step SE1106 of FIG. 11. This sequence corresponds to the processing sequence from 5-1 to 5-4 shown in FIG. 4. In the flowchart shown in FIG. 12, solid arrows indicate the sequence of processes, and broken arrows indicate data transmission/reception between apparatuses.

Steps SE1200 to SE1203 correspond to print job deletion instruction processing by the panel application 407 shown in FIG. 4. These flowchart processes are implemented by loading a program stored in the external memory into the RAM and executing it by the CPU of the multi-function peripheral 102 shown in FIG. 1.

Steps SC1200 to SC1207 correspond to print job deletion processing by the job management service 403 shown in FIG. 4. These flowchart processes are implemented by loading a program stored in the external memory into the RAM and executing it by the CPU of the print server 101 shown in FIG. 1.

Steps SD1200 to SD1204 correspond to print job identifier registration release processing by the address management service 405 shown in FIG. 4. These flowchart processes are implemented by loading a program stored in the external memory into the RAM and executing it by the CPU of the address management server 103 shown in FIG. 1.

First, print job deletion instruction processing by the panel application 407 will be explained. In step SE1200, processing by the panel application 407 starts. As described above, step SE1200 is called in step SE1106 of FIG. 11. This step is also called when pressing of an erase button 1421 in FIG. 15C is received from the user. In step SE1201, the panel application 407 acquires the GUID of a print job to be deleted. In step SE1202, the panel application 407 transmits a print job deletion instruction command to the job management service 403. At this time, the panel application 407 also transmits the GUID acquired in step SE1201. In step SE1203, the process ends.

Next, print job deletion processing by the job management service 403 will be explained. In step SC1200, processing by the job management service 403 starts. In step SC1201, the job management service 403 receives the print job deletion instruction command and the GUID of the print job to be deleted that have been transmitted from the panel application 407 in step SE1202. In step SC1202, the job management service 403 transmits, to the address management service 405, a print job identifier registration release command and the GUID received in step SC1201. In step SC1203, the job management service 403 searches the job management DB 404 in FIG. 4 for a record which matches the GUID received in step SC1201. In step SC1204, the job management service 403 acquires the file name of an EMFSPOOL print job from the detected record. In step SC1205, the job management service 403 deletes the EMFSPOOL print job based on the acquired file name. In step SC1206, the job management service 403 deletes, from the job management DB 404 in FIG. 4, the record detected in step SC1203. In step SC1207, the process ends.

Print job identifier registration release processing by the address management service 405 will be explained. In step SD1200, processing by the address management service 405 starts. In step SD1201, the address management service 405 receives the print job identifier registration release command and the GUID serving as a target print job identifier that have been transmitted from the job management service 403 in step SC1202. In step SD1202, the address management service 405 searches the address management DB 406 in FIG. 4 for a record which matches the GUID received in step SD1201. In step SD1203, the address management service 405 deletes the record detected in step SD1202 from the job management DB 404 in FIG. 4. In step SD1204, the process ends.

By the above sequence, when the user issues a print request from the printing apparatus for print data temporarily stored in the server, he can designate a change of print setting information. A program which runs on the printing apparatus and designates a change of print setting information requests a change of print setting information of a printer driver complying with the printing apparatus that resides not in the client PC but in the server. Hence, print setting information can be changed properly. While the user confirms a change of print setting information and a print job, a print job suited to the printing apparatus is prepared. This can shorten the user waiting time.

By the above sequence, when the user logs into the multi-function peripheral 102, the print server installs a printer driver and converts an EMFSPOOL print job into the PDL format for save in the multi-function peripheral 102. Meanwhile, the user confirms a change of print setting information and a print material using the panel application 407. When the user issues a print instruction next, whether print setting information has been changed is determined, thereby determining whether to use the saved PDL job or convert an EMFSPOOL print job again into the PDL format to change the print setting information. When the saved PDL job is used, neither printer driver installation nor PDL conversion takes time, and the print job can be output immediately after a print instruction. Even if print setting information has been changed, not so long time is taken because the printer driver has been installed. An optimum printing method can be automatically determined between these two systems based on determination of whether the user has changed print setting information.

### Second Embodiment

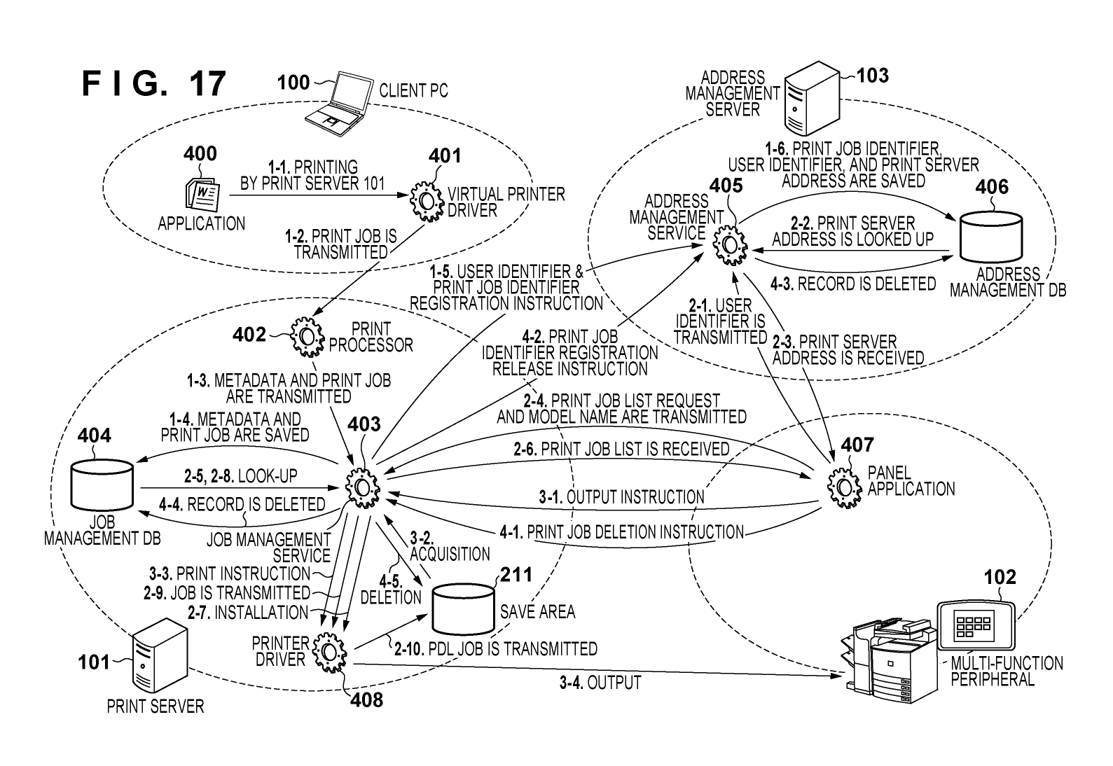

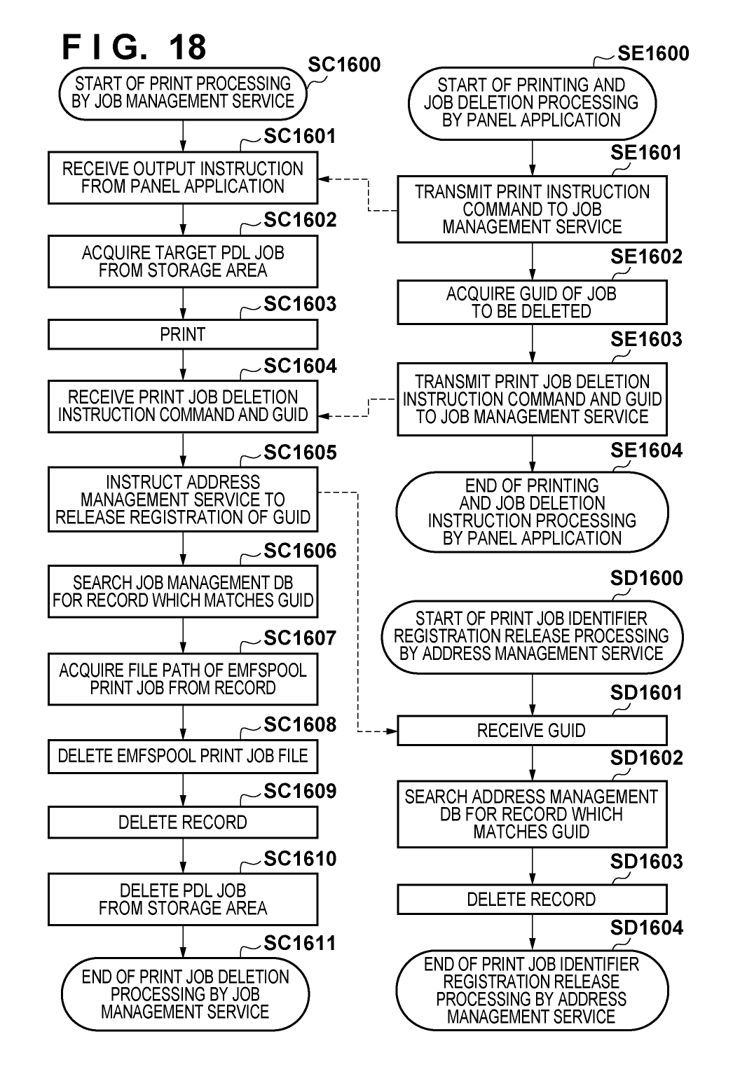

In the first embodiment, a PDL job is saved in the save area 304 of the multi-function peripheral 102. However, some multi-function peripherals do not have the save area. Hence, a system which uses an external memory 211 of a print server 101 as the save area will be described with reference to FIG. 17 and the flowchart of FIG. 18. In the second embodiment, the external memory 211 of the print server 101 shown in FIG. 1 will be referred to as the save area 211.

[Pull Print Processing Sequence]

Processes in 1-1 to 2-10 in FIG. 17 are the same as those in FIG. 4, and a description thereof will not be repeated. However, when a job management service 403 issues a save instruction to the printer driver 408, the destination of save by a printer driver 408 is the save area 211 ensured in the print server 101. The user selects a print job via the operation panel of a multi-function peripheral 102, and designates a change of print setting information and printing. In accordance with the designation, a panel application 407 confirms whether the print setting information has been changed on the panel application, and determines a print processing sequence. Processing when it is determined that the print setting information has been changed is the same as that in the first embodiment, and a description thereof will not be repeated.

If no print setting information has been changed, the panel application 407 issues a print instruction to the job management service 403 (3-1), and acquires a PDL job corresponding to the user-designated job from the save area 211 (3-2). The job management service 403 transmits, to the printer driver 408, the PDL job acquired from the save area 211, and issues a print instruction (3-3). The printer driver 408 acquires the PDL-converted job and directly transmits it to the multi-function peripheral 102. Then, the multi-function peripheral 102 executes print processing (3-4).

Finally, when the user designates deletion of a print job, the panel application 407 instructs the job management service 403 to delete the designated print job (4-1). This implements a deletion transmission unit. By receiving the deletion instruction, the job management service 403 implements a deletion reception unit. Upon receiving the print job deletion request from the panel application 407, the job management service 403 instructs an address management service 405 to delete the registered print job (4-2). Upon receiving the print job registration release request from the job management service 403, the address management service 405 deletes a corresponding record from an address management DB 406 (4-3). The job management service 403 deletes a corresponding record from a job management DB (4-4), and deletes even an EMFSPOOL print job. After that, the job management service 403 deletes a PDL job saved in the save area 211 (4-5).

The overall sequence of the pull print system in a multi-function peripheral having no save area has been described. Details of the processing will be explained with reference to the flowchart of FIG. 18. Note that a description of the same processes as those in the first embodiment will not be repeated.

[Third and Fourth Control Processes]

FIG. 18 is a flowchart exemplifying the third and fourth control processing sequences in the printing system according to the present invention. This sequence corresponds to the processing sequence from 3-1 to 3-3 and 4-1 to 4-5 shown in FIG. 17. In the flowchart shown in FIG. 18, solid arrows indicate the sequence of processes, and broken arrows indicate data transmission/reception between apparatuses.

Steps SE1600 to SE1604 correspond to processing by the panel application 407 shown in FIG. 17. These flowchart processes are implemented by loading a program stored in the external memory into the RAM and executing it by the CPU of the multi-function peripheral 102 shown in FIG. 1.

Steps SC1600 to SC1611 correspond to processing by the job management service 403 shown in FIG. 17. These flowchart processes are implemented by loading a program stored in the external memory into the RAM and executing it by the CPU of the print server 101 shown in FIG. 1.

Steps SD1600 to SD1604 correspond to processing by the address management service 405 shown in FIG. 17. These flowchart processes are implemented by loading a program stored in the external memory into the RAM and executing it by the CPU of the address management server 103 shown in FIG. 1.

First, printing and job deletion instruction processing by the panel application 407 will be explained. In step SE1600, processing by the panel application 407 starts. In step SE1601, the panel application 407 transmits a print instruction command to the job management service 403. In step SE1602, the panel application 407 acquires the GUID of a print job to be deleted. In the second embodiment, this step is called when a printed document erase check box 1435 in FIG. 16A is checked. In step SE1603, the panel application 407 transmits, to the job management service 403, a print job deletion instruction command and the GUID acquired in step SE1602. In step SE1604, the process ends.

Next, printing and job deletion processing by the job management service 403 will be explained. In step SC1600, processing by the job management service 403 starts. In step SC1601, the job management service 403 receives the print instruction command from the panel application 407. In step SC1602, the job management service 403 acquires a target PDL job from the save area 211. In step SC1603, the job management service 403 transmits the PDL job to be printed to the printer driver 408, and causes the multi-function peripheral 102 to print. At this time, no PDL conversion need be newly performed, so output can start immediately after the panel application 407 receives a print instruction from the user.

In step SC1604, the job management service 403 receives the print job deletion instruction command and the GUID of the print job to be deleted that have been transmitted from the panel application 407 in step SE1603. In step SC1605, the job management service 403 transmits, to the address management service 405, a print job identifier registration release command and the GUID received in step SC1604. In step SC1606, the job management service 403 searches a job management DB 404 in FIG. 4 for a record which matches the GUID received in step SC1604. In step SC1607, the job management service 403 acquires the file name of an EMFSPOOL print job from the detected record. In step SC1608, the job management service 403 deletes the EMFSPOOL print job. In step SC1609, the job management service 403 deletes, from the job management DB 404 in FIG. 4, the record detected in step SC1606. In step SC1610, the job management service 403 deletes the target PDL job from the save area 211. In step SC1611, the process ends.

Print job identifier registration release processing by the address management service 405 will be explained. In step SD1600, processing by the address management service 405 starts. In step SD1601, the address management service 405 receives the print job identifier registration release command and the GUID serving as a target print job identifier that have been transmitted from the job management service 403 in step SC1605. In step SD1602, the address management service 405 searches the address management DB 406 in FIG. 4 for a record which matches the GUID received in step SD1601. In step SD1603, the address management service 405 deletes the record detected in step SD1602 from the job management DB 404 in FIG. 4. In step SD1604, the process ends.

By the above sequence, the system according to the present invention can be applied to even a printing apparatus which cannot ensure a save area.

### Third Embodiment

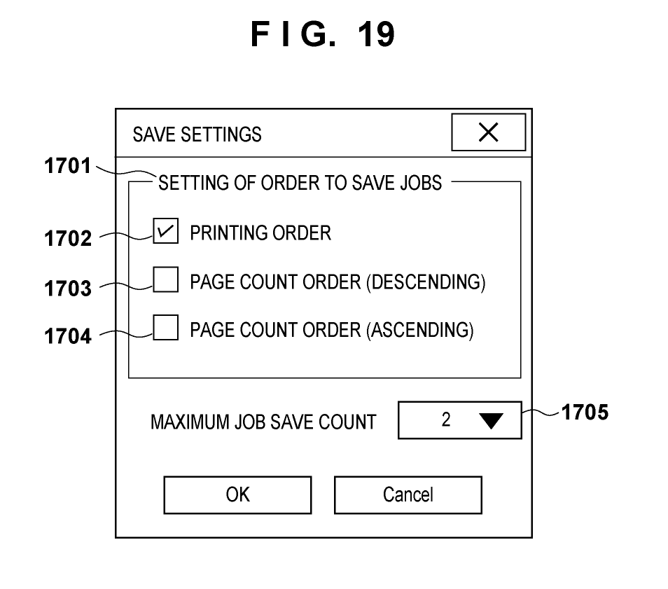

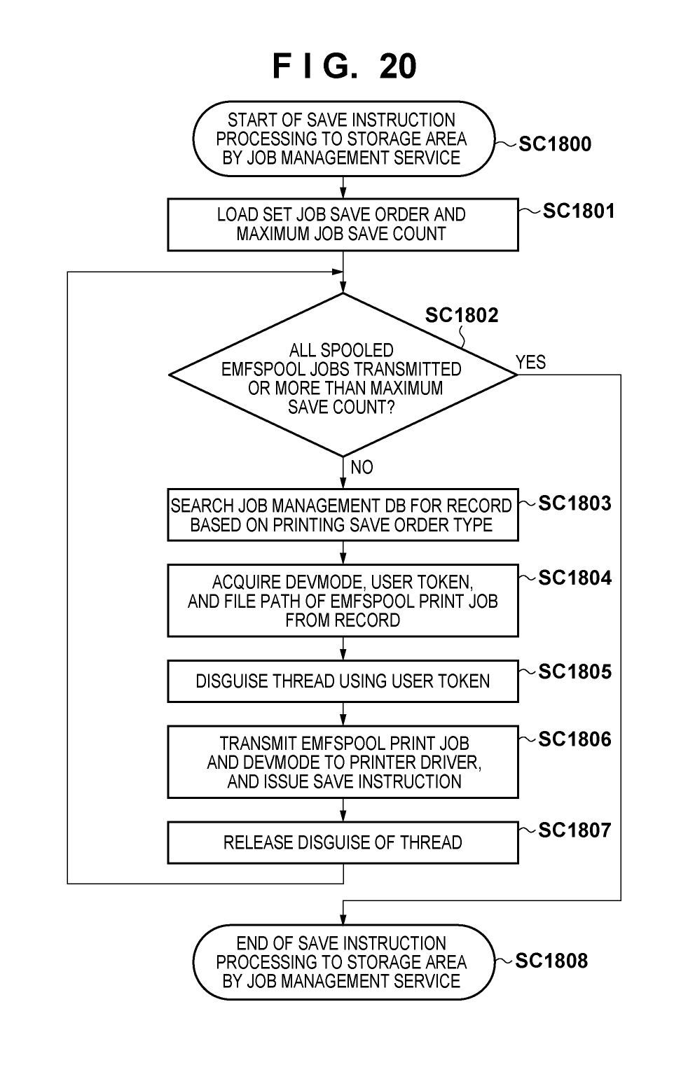

In the first embodiment, after the printer driver 408 is installed, the job management service 403 causes the printer driver 408 to perform PDL conversion using an EMFSPOOL print job and metadata. However, no search method has been designated for the job management DB 404, so the order of transmission to the printer driver 408 has not been determined. When many jobs are registered in the job management DB 404, saving all jobs may waste the save area more than necessary. To prevent this, the job search method for the job management service 403 and the maximum number of jobs to be saved in the save area need to be determined. The job search method and maximum job save count setting method will be described with reference to FIG. 19 and the flowchart of FIG. 20.

[Example of Save Setting Window]

FIG. 19 is a schematic view exemplifying a setting window regarding save of a job management service 403 running on a print server 101 shown in FIG. 1. This setting is assumed to be made by the server administrator before or during installation of the system.

In a job search method selection field 1701, a search method for an EMFSPOOL print job and metadata saved in a job management DB 404 is selected. A normal search method is a printing order 1702 indicating the order of transmission from a virtual printer driver 401. In a page count descending order 1703, EMFSPOOL print jobs with large page counts are preferentially searched for. By setting the page count descending order, the user can select another job and print it according to the sequence of 3-2-1 to 4-4 in FIG. 4 while an EMFSPOOL print job is kept saved.

In a page count ascending order 1704, EMFSPOOL print jobs with smaller page counts are preferentially searched for. By setting the page count ascending order, the time taken for save becomes shorter than that taken to save other jobs. Thus, PDL jobs are sequentially stored in a save area 304, and a multi-function peripheral 102 can print the stored PDL jobs. To set a PDL job savable count, a maximum job save count setting 1705 allows setting an arbitrary count. By restricting the save count, it can be set not to excessively waste the PDL job save area 304.

In this manner, the preferential order is defined using the print job characteristic (for example, the page count or print instruction reception order), and settings are made based on the preferential order. The system can be applied by a method suitable for the system user.

[Save Instruction Processing]

Details of processing will be explained with reference to the flowchart of FIG. 20. Note that a description of the same processes as those in the first embodiment will not be repeated. FIG. 20 is a flowchart exemplifying a save instruction processing sequence for the storage area in a printing system according to the present invention. The job save order and maximum job count need to be set in advance from the print setting window in FIG. 19.

Steps SC1800 to SC1808 correspond to processing by the job management service 403 shown in FIG. 1. These flowchart processes are implemented by loading a program stored in the external memory into the RAM and executing it by the CPU of the print server 101 shown in FIG. 1.

In step SC1800, processing by the job management service 403 starts. In step SC1801, the job management service 403 acquires a printing save order and maximum job save count which are set by the user via the window shown in FIG. 19. In step SC1802, the job management service 403 determines whether all spooled EMFSPOOL jobs have been transmitted to the printer driver 408 or the job count has exceeded the maximum save count acquired in step SC1801. If not all EMFSPOOL jobs have been transmitted or no job count has exceeded the maximum save count, the process advances to step SC1803. In step SC1803, the job management service 403 searches the job management DB 404 for a record in the job save order that has been acquired from the job management DB 404 in step SC1801.

In step SC1804, the job management service 403 acquires a DEVMODE, a user token, and the file path of an EMFSPOOL print job from the acquired record. In step SC1805, the job management service 403 disguises its thread using the user token acquired in step SC1804. In step SC1806, the job management service 403 transmits the EMFSPOOL print job and DEVMODE to a printer driver 408, and instructs the printer driver 408 to save them. In step SC1807, the job management service 403 releases the disguise of the thread, and the process advances to step SC1802. If the job management service 403 determines in step SC1802 that all spooled EMFSPOOL jobs have been transmitted to the printer driver 408 or the job count has exceeded the maximum save count acquired in step SC1801, the process advances to step SC1808. Then, save instruction processing for the storage area ends.

By the above sequence, save processing suitable for the system user can be set. Even if the maximum job save count is determined, the capacity of the save area 304 may be short and not enough to save print jobs. In this case, the printer driver 408 performs PDL conversion again using an EMFSPOOL print job and metadata, and outputs the print job. This method has been described in the first embodiment, and a description thereof will not be repeated here.

### Fourth Embodiment

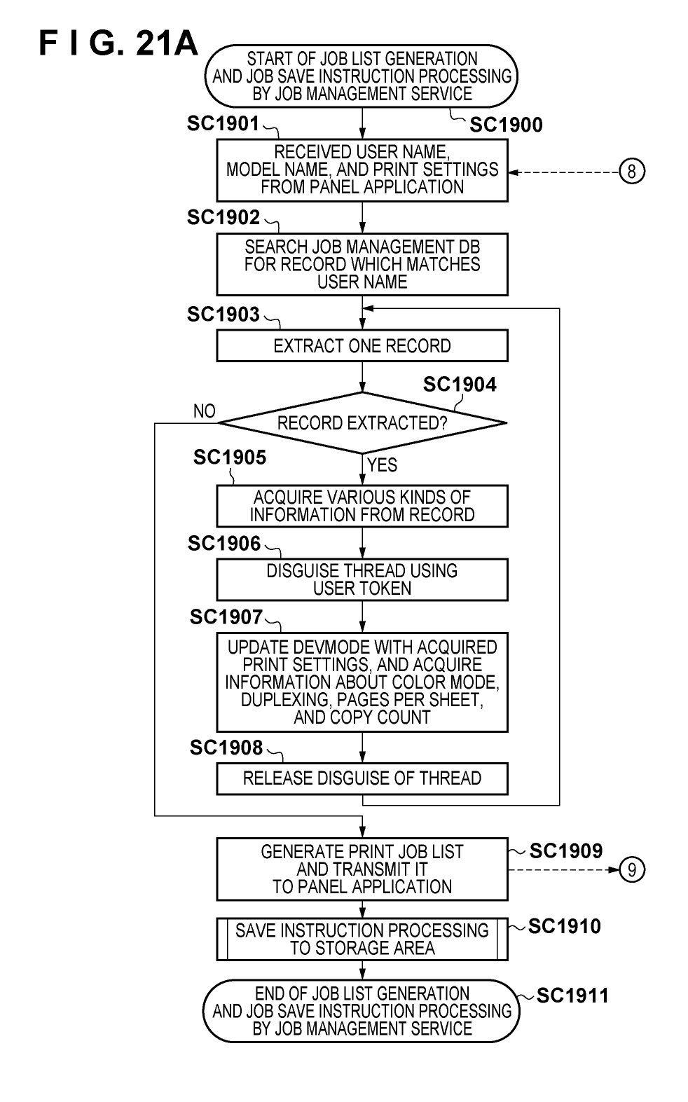

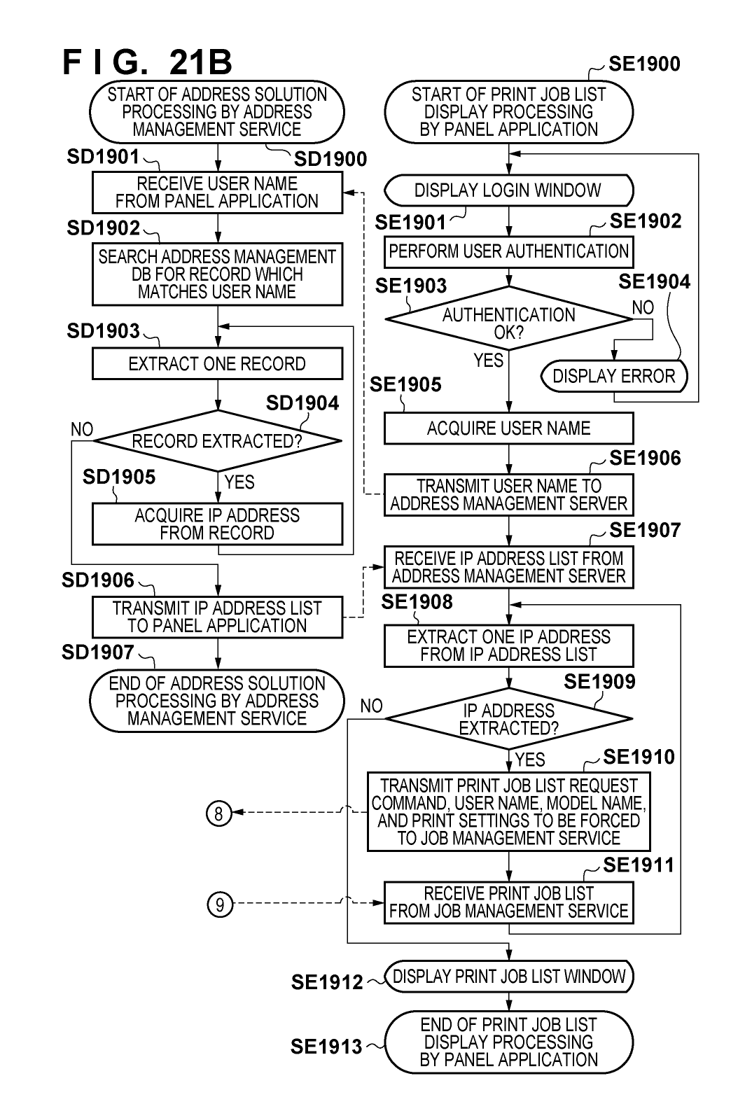

In the first embodiment, a PDL job to be saved is generated using metadata set by the virtual printer driver of the client PC 100. However, print setting information settable by the virtual printer driver 401 is limited to general-purpose one independent of the printing apparatus because a printing apparatus to output has not been finalized yet. Thus, the virtual printer driver may not be able to set the save processing function. Further, the system administrator desirably forces user print setting information such as eco-printing (for example, print setting information of monochrome, two-sided printing, and 2in1). From this, print setting information set in a panel application 407 in advance is transmitted to a multi-function peripheral 102 at the same time as a model name, thereby forcing print setting information with which a print job is saved. This method will be explained with reference to the flowchart of FIG. 21.

[Fourth Control Processing]

FIG. 21 is a flowchart exemplifying the fourth control processing sequence in the printing system according to the present invention. In the flowchart shown in FIG. 21, solid arrows indicate the sequence of processes, and broken arrows indicate data transmission/reception between apparatuses.

Steps SE1900 to SE1913 correspond to print job list display processing by the panel application 407 shown in FIG. 4. These flowchart processes are implemented by loading a program stored in the external memory into the RAM and executing it by the CPU of the multi-function peripheral 102 shown in FIG. 1.

Steps SD1900 to SD1907 correspond to address solution processing by an address management service 405 shown in FIG. 4. These flowchart processes are implemented by loading a program stored in the external memory into the RAM and executing it by the CPU of an address management server 103 shown in FIG. 1.

Steps SC1900 to SC1911 correspond to print job list generation and job save instruction processing by a job management service 403 shown in FIG. 4. These flowchart processes are implemented by loading a program stored in the external memory into the RAM and executing it by the CPU of a print server 101 shown in FIG. 1.

First, print job list display processing by the panel application 407 will be explained. Steps SE1900 to SE1909 are the same as those in the first embodiment, and a description thereof will not be repeated.

In step SE1910, the panel application 407 transmits a print job list request command to the job management service 403. At this time, the panel application 407 transmits a user name, model name, and print setting information to be forced for a user-designated print job. In this case, the system administrator needs to set print setting information to be forced in advance via a setting window as shown in FIG. 16A. The panel application 407 needs to store print setting information set for each multi-function peripheral. Data to be stored/transmitted is expressed in the XML format as shown in FIG. 13A. For descriptive convenience, the print setting information to be forced will be referred to as forced print setting information. The forced print setting information is stored in a storage unit such as an external memory 211, implementing a forced setting holding unit.

In step SE1911, the panel application 407 receives a print job list from the job management service 403. After the end of extracting an IP address from the IP address list in steps SE1908 to SE1911, the process advances to step SE1912. In step SE1912, the panel application 407 controls to display the print job list display window (FIG. 15C) on the display unit of an operation unit 308. In step SE1913, the process ends.

Address solution processing (steps SD1900 to SD1907) by the address management service 405 is the same as that in the first embodiment, and a description thereof will not be repeated.

Next, print job list generation and job save instruction processing by the job management service 403 will be explained. In step SC1900, processing by the job management service 403 starts. In step SC1901, the job management service 403 receives a print job list request transmitted from the panel application 407 in step SE1910. At this time, the job management service 403 receives the user name, model name, and forced print setting information, too. The acquired print setting information is expressed in the XML format as shown in FIG. 13A. In step SC1902, the job management service 403 searches a job management DB 404 in FIG. 4 for a record which matches the user name received in step SC1901.

In step SC1903, the job management service 403 extracts one record from detected records. In step SC1904, the job management service 403 determines whether the record has been extracted. If the record has been extracted, the process advances to step SC1905. The job management service 403 extracts a GUID, a job name, a DEVMODE, the logical printer name of a virtual printer driver, a user token, and date & time from the record. In step SC1906, the job management service 403 disguises its thread using the user token extracted in step SC1905. While the thread is disguised, it is executed in the security context of a user who printed using a client application 400 in FIG. 4.

In step SC1907, the job management service 403 updates the DEVMODE extracted in step SC1905 by the print setting information received in step SC1901, and registers the updated DEVMODE in the job management DB 404. The job management service 403 extracts pieces of information such as the color mode, duplexing, pages per sheet, and copy count from the updated DEVMODE. In step SC1908, the job management service 403 releases the disguise of the thread. After the end of extracting pieces of print setting information from all detected records in steps SC1903 to SC1908, the process advances to step SC1909. The job management service 403 generates a print job list (FIGS. 14A and 14B). The job management service 403 sends back the print job list to the panel application 407. The process in step SC1910 is the same as that in the first embodiment, and a description thereof will not be repeated. In step SC1911, the process ends.

By the above sequence, the panel application 407 sets print setting information to be forced. A PDL job which reflects the print setting information can be saved.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-222436, filed Sep. 30, 2010, which is hereby incorporated by reference herein in its entirety.

What is claimed is:

1. A printing system comprising an information processing apparatus including a virtual printer driver which generates a print job of an intermediate format independent of a printing apparatus, a print server which manages the print job, and a printing apparatus,
wherein said print server includes
a storage unit configured to store the print job of the intermediate format received from said information processing apparatus,
a conversion unit configured to convert the print job of the intermediate format stored in said storage unit into a first PDL print job printable by said printing apparatus by using a printer driver of said printing apparatus, and
a transmission unit configured to transmit the first PDL print job to save the first PDL print job converted by said conversion unit in said printing apparatus,
said storage unit stores the print job of the intermediate format even after generating the first PDL print job,
upon receiving a print setting change instruction from said printing apparatus for the print job, said transmission unit transmits, to said printing apparatus, a second PDL print job generated based on changed print setting information and the print job of the intermediate format stored in said storage unit,
said printing apparatus includes
a save unit configured to save the first PDL print job transmitted from said transmission unit,
a printing unit configured to print the print job,
a selection unit configured to select a print job, and
a setting change transmission unit configured to transmit a print setting information change instruction for the print job selected by said selection unit,
when said setting change transmission unit transmits the print setting information change instruction, said printing unit prints using the second PDL print job transmitted from said print server, and
when said setting change transmission unit does not transmit the print setting information change instruction, said printing unit prints using the first PDL print job saved in said save unit.

2. The system according to claim 1, wherein said transmission unit determines, in a preferential order defined in advance in accordance with a characteristic of the print job, an order in which print jobs are saved.

3. The system according to claim 2, wherein the characteristic of the print job for defining the preferential order is at least one of a printing order of print jobs and a page count in a print job.

4. The system according to claim 1, wherein said transmission unit can define a savable print job count.

5. The system according to claim 1, wherein
said printing apparatus further includes a forced setting holding unit configured to hold in advance a forced print setting to be applied to a print job managed in said print server,
when transmitting a print job list request, the forced print setting is further transmitted to said print server, and
said print server transmits, to said printing apparatus, print job list information containing a print job that has been set using the forced print setting received from said printing apparatus.

6. A print server which communicates with an information processing apparatus including a virtual printer driver that generates a print job of an intermediate format independent of a printing apparatus, and a printing apparatus, comprising:
a storage unit configured to store the print job of the intermediate format received from the information processing apparatus;
a conversion unit configured to convert the print job of the intermediate format stored in said storage unit into a first PDL print job printable by the printing apparatus by using a printer driver of the printing apparatus; and
a transmission unit configured to transmit the first PDL print job to save the first PDL print job converted by said conversion unit in the printing apparatus,
wherein said storage unit stores the print job of the intermediate format even after generating the first PDL print job, and
upon receiving a print setting change instruction from the printing apparatus for the print job, said transmission unit transmits, to the printing apparatus, a second PDL print job generated based on changed print setting information and the print job of the intermediate format stored in said storage unit.

7. A printing method in a printing system including an information processing apparatus including a virtual printer driver which generates a print job of an intermediate format independent of a printing apparatus, a print server which manages the print job, and a printing apparatus, comprising in the print server:
a storage step of storing, in a storage unit, the print job of the intermediate format received from the information processing apparatus;
a conversion step of converting the print job of the intermediate format stored in the storage unit into a first PDL print job printable by the printing apparatus by using a printer driver of the printing apparatus; and
a transmission step of transmitting the first PDL print job to save the first PDL print job converted in the conversion step in the printing apparatus,
wherein in the storage step, the print job of the intermediate format is stored even after generating the first PDL print job, and
in the transmission step, upon receiving a print setting change instruction from the printing apparatus for the print job, a second PDL print job generated based on changed print setting information and the print job of the intermediate format stored in the storage unit is transmitted to the printing apparatus, and comprising in the printing apparatus:
a save step of saving, in a save unit, the first PDL print job transmitted in the transmission step;
a printing step of printing the print job;
a selection step of selecting a print job; and
a setting change transmission step of transmitting a print setting information change instruction for the print job selected in the selection step,
wherein in the printing step, when the print setting information change instruction is transmitted in the setting change transmission step, printing is performed using the second PDL print job transmitted from the print server, and
when the print setting information change instruction is not transmitted in the setting change transmission step, printing is performed using the first PDL print job saved in the save unit.

8. A method of controlling a print server which communicates with an information processing apparatus including a virtual printer driver that generates a print job of an intermediate format independent of a printing apparatus, and a printing apparatus, comprising:
a storage step of storing, in a storage unit, the print job of the intermediate format received from the information processing apparatus;
a conversion step of converting the print job of the intermediate format stored in the storage unit into a first PDL print job printable by the printing apparatus by using a printer driver of the printing apparatus; and
a transmission step of transmitting the first PDL print job to save the first PDL print job converted in the conversion step in the printing apparatus,
wherein in the storage step, the print job of the intermediate format is stored even after generating the first PDL print job, and
in the transmission step, upon receiving a print setting change instruction from the printing apparatus for the print job, a second PDL print job generated based on changed print setting information and the print job of the intermediate format stored in the storage unit is transmitted to the printing apparatus.

9. A computer-readable medium storing a program for causing a computer to function as
a storage unit which stores a print job of an intermediate format received from an information processing apparatus,
a conversion unit which converts the print job of the intermediate format stored in said storage unit into a first PDL print job printable by a printing apparatus by using a printer driver of the printing apparatus, and
a transmission unit which transmits the first PDL print job to save the first PDL print job converted by said conversion unit in the printing apparatus,
wherein said storage unit stores the print job of the intermediate format even after generating the first PDL print job, and
upon receiving a print setting change instruction from the printing apparatus for the print job, said transmission unit transmits, to the printing apparatus, a second PDL print job generated based on changed print setting information and the print job of the intermediate format stored in said storage unit.
